(19) United States
(12) Patent Application Publication
(10) Pub. No.: US 2025/0282138 A1
(43) Pub. Date: Sep. 11, 2025

(54) Print Head And Liquid Discharge Apparatus

(71) Applicant: SEIKO EPSON CORPORATION, Tokyo (JP)

(72) Inventor: Toshimichi YAMADA, Chino (JP)

(21) Appl. No.: 19/071,920

(22) Filed: Mar. 6, 2025

(30) Foreign Application Priority Data
Mar. 7, 2024 (JP) 2024-035026

(51) Int. Cl. B41J 2/045

(52) U.S. Cl. CPC B41J 2/0455; B41J 2/04548; B41J 2/0457; B41J 2/04573; B41J 2/04581; B41J 2/04588

(57) ABSTRACT

A print head includes a pressure chamber whose volume changes according to a drive signal, a nozzle communicating with the pressure chamber and configured to allow a liquid to be discharged, a piezoelectric element configured to output a residual vibration signal corresponding to a residual vibration caused by a change in the volume of the pressure chamber, a residual vibration detection circuit configured to receive the residual vibration signal and output a residual vibration detection signal corresponding to the residual vibration signal, and a first switch circuit configured to switch whether to supply the residual vibration signal to the residual vibration detection circuit. The first switch circuit is an N-channel type transistor.

The present application is based on, and claims priority from JP Application Serial Number 2024-035026, filed Mar. 7, 2024, the disclosure of which is hereby incorporated by reference herein in its entirety.

### BACKGROUND

### 1. Technical Field

The present disclosure relates to a print head and a liquid discharge apparatus.

### 2. Related Art

As disclosed in JP-A-2015-039856, in a liquid discharge apparatus that discharges ink from a discharge portion by driving a piezoelectric element, it is known a technique of detecting a signal corresponding to a residual vibration generated after the piezoelectric element is driven and determining a state of the discharge portion based on a detection result of the signal.

However, from the viewpoint of further improving detection accuracy of the residual vibration generated after the piezoelectric element is driven, the technique disclosed in JP-A-2015-039856 is not sufficient, and there is room for further improvement.

### SUMMARY

An aspect of a print head according to the disclosure includes:
a pressure chamber whose volume changes according to a drive signal;
a nozzle communicating with the pressure chamber and configured to allow a liquid to be discharged;
a piezoelectric element configured to output a residual vibration signal corresponding to a residual vibration caused by a change in the volume of the pressure chamber;
a residual vibration detection circuit configured to receive the residual vibration signal and output a residual vibration detection signal corresponding to the residual vibration signal; and
a first switch circuit configured to switch whether to supply the residual vibration signal to the residual vibration detection circuit, in which
the first switch circuit is an N-channel type transistor.

An aspect of a liquid discharge apparatus according to the disclosure includes:
a drive circuit configured to output a drive signal;
a pressure chamber whose volume changes according to the drive signal;
a nozzle communicating with the pressure chamber and configured to allow a liquid to be discharged;
a piezoelectric element configured to output a residual vibration signal corresponding to a residual vibration caused by a change in the volume of the pressure chamber;
a residual vibration detection circuit configured to receive the residual vibration signal and output a residual vibration detection signal corresponding to the residual vibration signal;
a first switch circuit configured to switch whether to supply the residual vibration signal to the residual vibration detection circuit; and
a processor configured to determine a discharge state of the liquid from the nozzle based on the residual vibration detection signal, in which
the first switch circuit is an N-channel type transistor.

### BRIEF DESCRIPTION OF THE DRAWINGS

FIG. 1 shows a schematic configuration of a liquid discharge apparatus.

FIG. 2 shows a schematic configuration of a discharge unit.

FIG. 3 shows a schematic configuration of a discharge portion.

FIG. 4 shows an example of a signal waveform of a drive voltage signal COM.

FIG. 5 shows an example of a functional configuration of a drive signal selection circuit.

FIG. 6 shows an example of decoded contents in a decoder.

FIG. 7 shows an example of circuit configurations of a selection circuit, a switching circuit, and a residual vibration detection circuit of the drive signal selection circuit.

FIG. 8 shows an example of an operation of the drive signal selection circuit.

FIG. 9 shows an example of a structure of an integrated circuit.

FIG. 10 shows an example of a configuration of a mounting region Sel where the selection circuit is mounted.

FIG. 11 shows an example of a configuration of a mounting region Sw where a switch circuit is mounted.

FIG. 12 shows an example of a residual vibration signal Vout.

FIG. 13 shows an example of a calculation model of a simple harmonic motion assuming a residual vibration generated at a pressure chamber or a vibration plate.

FIG. 14 shows a relationship between viscosity of ink and a signal waveform of the residual vibration signal Vout.

FIG. 15 shows the signal waveform of the residual vibration signal Vout when an air bubble is mixed into the pressure chamber.

FIG. 16 shows an example of circuit configurations of a selection circuit, a switching circuit, and a residual vibration detection circuit of a drive signal selection circuit in a second embodiment.

FIG. 17 shows an example of a configuration of the mounting region Sel where the selection circuit in the second embodiment is mounted.

FIG. 18 shows an example of a configuration of the mounting region Sw where a switch circuit in the second embodiment is mounted.

FIG. 19 shows an example of a structure of an integrated circuit in the second embodiment.

### DESCRIPTION OF EMBODIMENTS

Preferred embodiments of the disclosure will hereinafter be described using the drawings. The drawings to be used are for the sake of convenience of description. The embodiments to be described below do not unduly limit contents of the disclosure described in the claims. All configurations to be described below are not necessarily essential elements of the disclosure.

### 1. First Embodiment

### 1.1 Configuration of Liquid Discharge Apparatus

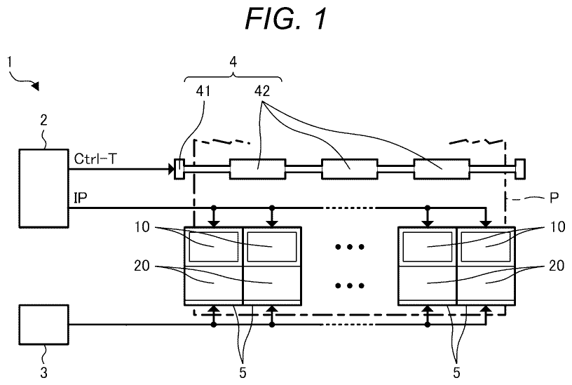

FIG. 1 shows a schematic configuration of a liquid discharge apparatus 1. As shown in FIG. 1, the liquid discharge apparatus 1 is a so-called line type inkjet printer that discharges ink as an example of a liquid at desired timing to a medium P conveyed by a conveyance unit 4 to form a desired image on the medium P. The liquid discharge apparatus 1 is not limited to the line type inkjet printer, and may be a serial type inkjet printer. In addition, the liquid discharge apparatus 1 is not limited to the inkjet printer, and may be a color material discharge apparatus used for producing a color filter for a liquid crystal display or the like, an electrode material discharge apparatus used for forming an electrode for an organic EL display, a field emission display (FED), or the like, an organic biological substance discharge apparatus used for producing a biochip, or the like, and may further be a three-dimensional fabrication apparatus, a textile printing apparatus, or the like. Here, in the following description, a direction in which the medium P is conveyed may be referred to as a conveyance direction, and a width direction of the medium P thus conveyed may be referred to as a scanning direction.

As shown in FIG. 1, the liquid discharge apparatus 1 includes a control unit 2, a liquid container 3, the conveyance unit 4, and a plurality of discharge units 5.

The control unit 2 includes a processing circuit such as a central processing unit (CPU) or a field programmable gate array (FPGA), and a storage circuit such as a semiconductor memory. The control unit 2 outputs a signal for controlling each element of the liquid discharge apparatus 1 based on image data supplied from an external device such as a host computer (not shown) provided outside the liquid discharge apparatus 1.

The liquid container 3 stores ink that is an example of a liquid to be supplied to the discharge units 5. Specifically, the liquid container 3 stores ink of a plurality of colors to be discharged to the medium P such as black ink, cyan ink, magenta ink, yellow ink, red ink, and gray ink. As such a liquid container 3, an ink cartridge, a bag-shaped ink pack formed of a flexible film, an ink tank that can be refilled with ink, or the like may be used.

The conveyance unit 4 includes a conveyance motor 41 and a conveyance roller 42. The conveyance unit 4 receives a conveyance control signal Ctrl-T output from the control unit 2. The conveyance motor 41 drives based on the conveyance control signal Ctrl-T, and the conveyance roller 42 rotates as the conveyance motor 41 drives. Due to the rotation of the conveyance roller 42, the medium P is conveyed along the conveyance direction.

Each of the plurality of discharge units 5 includes a drive module 10 and a discharge module 20. Each of the plurality of discharge units 5 receives a corresponding image information signal IP output from the control unit 2, and the ink stored in the liquid container 3 is supplied thereto. The drive module 10 controls an operation of the discharge module 20 based on the image information signal IP. Accordingly, the discharge module 20 discharges the ink supplied from the liquid container 3 at predetermined timing according to the control of the drive module 10.

In the liquid discharge apparatus 1 according to the embodiment, discharge modules 20 of the plurality of discharge units 5 are located side by side along the scanning direction such that a width thereof is equal to or larger than that of the medium P. The drive module 10 of each of the plurality of discharge units 5 causes the ink to be discharged from the discharge module 20 at timing synchronized with the conveyance of the medium P. The ink discharged from each of the plurality of discharge modules 20 is deposited at a desired position on the medium P. Accordingly, a desired image is formed on the medium P.

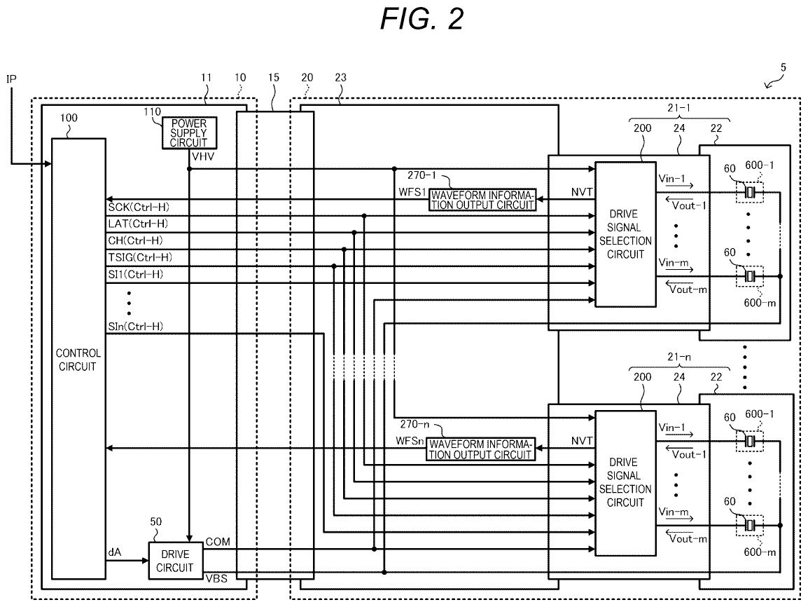

Next, a schematic configuration of the discharge unit 5 will be described. FIG. 2 shows the schematic configuration of the discharge unit 5. As shown in FIG. 2, the discharge unit 5 includes the drive module 10 and the discharge module 20. In the discharge unit 5, the drive module 10 and the discharge module 20 are electrically coupled via a cable 15. Here, examples of the cable 15 for electrically coupling the drive module 10 and the discharge module 20 include a flexible flat cable (FFC) and a flexible printed circuit (FPC). The drive module 10 and the discharge module 20 may be electrically coupled with a board-to-board (BtoB) connector without using the cable 15, or may be electrically coupled with both the cable 15 and the BtoB connector.

The drive module 10 includes a control circuit board 11, a drive circuit 50, a control circuit 100, and a power supply circuit 110.

The power supply circuit 110 converts a commercial voltage signal received by the liquid discharge apparatus 1 into a DC voltage signal having a constant voltage value, for example, a DC voltage signal having a voltage value of 42 V, and outputs the converted DC voltage signal as a voltage signal VHV. The voltage signal VHV output from the power supply circuit 110 is received by the drive circuit 50 and also by the discharge module 20. Such a power supply circuit 110 is a switching regulator that can efficiently convert the commercial voltage signal into the DC voltage signal, and for example, a flyback circuit may be used. The DC voltage signal including the voltage signal VHV output from the power supply circuit 110 may be received by various configurations of the liquid discharge apparatus 1 in addition to the drive circuit 50 and the discharge module 20. The voltage value of the voltage signal VHV output from the power supply circuit 110 is not limited to 42 V, and the power supply circuit 110 may output DC voltage signals of a plurality of voltage values used in the liquid discharge apparatus 1 in addition to the voltage signal VHV.

The control circuit board 11 is a printed circuit board having one or a plurality of wiring layers, and a glass epoxy board, a glass polyimide board, or the like may be used. Elements constituting the drive module 10 including the drive circuit 50, the control circuit 100, and the power supply circuit 110 are mounted at the control circuit board 11. The control circuit board 11 where the elements constituting the drive module 10 are mounted may be formed of a single printed circuit board or a plurality of printed circuit boards.

The control circuit 100 is a processor, and includes, for example, a processing circuit such as a CPU or an FPGA and a storage circuit such as a semiconductor memory. The image information signal IP output from the control unit 2 is received by the control circuit 100. The control circuit 100 generates signals for controlling operations of the drive module 10 and the discharge module 20 based on the received image information signal IP, and outputs the signals.

Specifically, the control circuit 100 generates, based on the received image information signal IP, a clock signal SCK, a latch signal LAT, a change signal CH, a test timing signal TSIG, and print data signals SI1 to SIn, and outputs these signals to the discharge module 20.

The control circuit 100 generates a base drive signal dA and outputs the base drive signal dA to the drive circuit 50. The drive circuit 50 generates a drive voltage signal COM including a signal waveform defined by the received base drive signal dA, and outputs the drive voltage signal COM to the discharge module 20. Specifically, the control circuit 100 generates the base drive signal dA that is a digital signal, and outputs the base drive signal dA to the drive circuit 50. The drive circuit 50 converts the received base drive signal dA, which is the digital signal, into an analog signal, and then generates the drive voltage signal COM by performing D-class amplification on the converted analog signal based on the voltage signal VHV. The drive circuit 50 outputs the generated drive voltage signal COM to the discharge module 20. That is, the control circuit 100 outputs the base drive signal dA that defines the signal waveform of the drive voltage signal COM output from the drive circuit 50. The base drive signal dA may be an analog signal as long as the base drive signal dA is a signal that can define the signal waveform of the drive voltage signal COM. The drive circuit 50 may generate the drive voltage signal COM by amplifying, based on the voltage signal VHV, the signal waveform defined by the base drive signal dA, or may generate the drive voltage signal COM by performing A-class amplification, B-class amplification, or AB-class amplification instead of or in addition to the D-class amplification.

The drive circuit 50 generates a reference voltage signal VBS and outputs the reference voltage signal VBS to the discharge module 20. The reference voltage signal VBS is a signal that has a constant voltage value and defines a reference potential for driving a piezoelectric element 60 to be described later. The voltage value of such a reference voltage signal VBS may be, for example, a ground potential, or may be 5.5 V or 6 V. In FIG. 2, it is shown that the drive circuit 50 generates the reference voltage signal VBS and outputs the reference voltage signal VBS to the discharge module 20, and alternatively, the reference voltage signal VBS may be generated by a constant voltage output circuit or the like (not shown) provided separately from the drive circuit 50.

Waveform information signals WFS1 to WFSn are received by the control circuit 100 from the discharge module 20 to be described later. The control circuit 100 determines whether a discharge state of ink from the discharge module 20 is normal based on the received waveform information signals WFS1 to WFSn. Details of the waveform information signals WFS1 to WFSn received by the control circuit 100, and details of a method for determining whether the discharge state of ink from the discharge module 20 is normal based on the waveform information signals WFS1 to WFSn will be described later.

The discharge module 20 includes print heads 21-1 to 21-n, a head circuit board 23, and waveform information output circuits 270-1 to 270-n. Each of the print heads 21-1 to 21-n includes a head chip 22, a flexible board 24, and a drive signal selection circuit 200. Each head chip 22 of each of the print heads 21-1 to 21-n includes discharge portions 600-1 to 600-m, and further, each of the discharge portions 600-1 to 600-m includes the piezoelectric element 60.

The clock signal SCK, the latch signal LAT, the change signal CH, the test timing signal TSIG, the print data signals SI1 to SIn, the drive voltage signal COM, the reference voltage signal VBS, and the voltage signal VHV output from the drive module 10 are received by the discharge module 20.

The head circuit board 23 propagates, to the corresponding print heads 21-1 to 21-n, the clock signal SCK, the latch signal LAT, the change signal CH, the test timing signal TSIG, the print data signals SI1 to SIn, the drive voltage signal COM, the reference voltage signal VBS, and the voltage signal VHV thus received. Such a head circuit board 23 is a printed circuit board having one or a plurality of wiring layers, and for example, a glass epoxy board or a glass polyimide board may be used.

Specifically, among the clock signal SCK, the latch signal LAT, the change signal CH, the test timing signal TSIG, the print data signals SI1 to SIn, the drive voltage signal COM, the reference voltage signal VBS, and the voltage signal VHV thus received, the head circuit board 23 propagates the clock signal SCK, the latch signal LAT, the change signal CH, the test timing signal TSIG, the print data signal SI1, the drive voltage signal COM, the reference voltage signal VBS, and the voltage signal VHV to the print head 21-1, and propagates the clock signal SCK, the latch signal LAT, the change signal CH, the test timing signal TSIG, the print data signal SIn, the drive voltage signal COM, the reference voltage signal VBS, and the voltage signal VHV to the print head 21-n.

Among the clock signal SCK, the latch signal LAT, the change signal CH, the test timing signal TSIG, the print data signals SI1, the drive voltage signal COM, the reference voltage signal VBS, and the voltage signal VHV received by the print head 21-1, the clock signal SCK, the latch signal LAT, the change signal CH, the test timing signal TSIG, the print data signals SI1, the drive voltage signal COM, and the voltage signal VHV are received by the drive signal selection circuit 200 of the print head 21-1. The drive signal selection circuit 200 of the print head 21-1 selects or deselects a signal waveform contained in the drive voltage signal COM based on the clock signal SCK, the latch signal LAT, the change signal CH, the test timing signal TSIG, and the print data signal SI1 thus received to generate and output drive voltage signals Vin-1 to Vin-m.

The drive voltage signals Vin-1 to Vin-m output from the drive signal selection circuit 200 of the print head 21-1 are supplied to the corresponding discharge portions 600-1 to 600-m of the head chip 22 of the print head 21-1. Specifically, among the drive voltage signals Vin-1 to Vin-m output from the drive signal selection circuit 200 of the print head 21-1, the drive voltage signal Vin-1 is supplied to one end of the piezoelectric element 60 provided at the discharge portion 600-1 of the head chip 22 of the print head 21-1, and the drive voltage signal Vin-m is supplied to one end of the piezoelectric element 60 provided at the discharge portion 600-m of the head chip 22 of the print head 21-1. At this time, the reference voltage signal VBS is commonly supplied to the other end of the piezoelectric element 60 provided at each of the discharge portions 600-1 to 600-m of the head chip 22 of the print head 21-1. The piezoelectric element 60 provided at each of the discharge portions 600-1 to 600-m of the head chip 22 of the print head 21-1 is driven according to a potential difference between a voltage value of the corresponding drive voltage signals Vin-1 to Vin-m supplied to the one end and a voltage value of the reference voltage signal VBS supplied to the other end. An amount of ink corresponding to the drive of the piezoelectric element 60 is discharged from the discharge portions 600-1 to 600-m of the print head 21-1.

In each of the discharge portions 600-1 to 600-m of the head chip 22 of the print head 21-1, a residual vibration occurs after the piezoelectric element 60 provided therein is driven. The piezoelectric element 60 provided at each of the discharge portions 600-1 to 600-m of the head chip 22 of the print head 21-1 displaces corresponding to the residual vibration generated at the respective discharge portions 600-1 to 600-m. The piezoelectric element 60 provided at each of the discharge portions 600-1 to 600-m of the print head 21-1 outputs residual vibration signals Vout-1 to Vout-m corresponding to the displacement. The residual vibration signals Vout-1 to Vout-m are received by the drive signal selection circuit 200 of the print head 21-1. Then, the drive signal selection circuit 200 of the print head 21-1 generates a residual vibration detection signal NVT corresponding to the received residual vibration signals Vout-1 to Vout-m, and outputs the residual vibration detection signal NVT from the print head 21-1.

Such a drive signal selection circuit 200 of the print head 21-1 is implemented as an integrated circuit apparatus, and may be chip-on-film-mounted (COF-mounted) at the flexible board 24 of the print head 21-1.

Among the clock signal SCK, the latch signal LAT, the change signal CH, the test timing signal TSIG, the print data signals SIn, the drive voltage signal COM, the reference voltage signal VBS, and the voltage signal VHV received by the print head 21-n, the clock signal SCK, the latch signal LAT, the change signal CH, the test timing signal TSIG, the print data signals SIn, the drive voltage signal COM, and the voltage signal VHV are received by the drive signal selection circuit 200 of the print head 21-n. The drive signal selection circuit 200 of the print head 21-n selects or deselects the signal waveform contained in the drive voltage signal COM based on the clock signal SCK, the latch signal LAT, the change signal CH, the test timing signal TSIG, and the print data signal SIn thus received to generate and output the drive voltage signals Vin-1 to Vin-m.

The drive voltage signals Vin-1 to Vin-m output from the drive signal selection circuit 200 of the print head 21-n are supplied to the corresponding discharge portions 600-1 to 600-m of the head chip 22 of the print head 21-n. Specifically, among the drive voltage signals Vin-1 to Vin-m output from the drive signal selection circuit 200 of the print head 21-n, the drive voltage signal Vin-1 is supplied to one end of the piezoelectric element 60 provided at the discharge portion 600-1 of the head chip 22 of the print head 21-n, and the drive voltage signal Vin-m is supplied to one end of the piezoelectric element 60 provided at the discharge portion 600-m of the head chip 22 of the print head 21-n. At this time, the reference voltage signal VBS is commonly supplied to the other end of the piezoelectric element 60 provided at each of the discharge portions 600-1 to 600-m of the head chip 22 of the print head 21-n. The piezoelectric element 60 provided at each of the discharge portions 600-1 to 600-m of the head chip 22 of the print head 21-n is driven according to a potential difference between a voltage value of the corresponding drive voltage signals Vin-1 to Vin-m supplied to the one end and a voltage value of the reference voltage signal VBS supplied to the other end. An amount of ink corresponding to the drive of the piezoelectric element 60 is discharged from the discharge portions 600-1 to 600-m of the print head 21-n.

In each of the discharge portions 600-1 to 600-m of the head chip 22 of the print head 21-n, a residual vibration occurs after the piezoelectric element 60 provided therein is driven. The piezoelectric element 60 provided at each of the discharge portions 600-1 to 600-m of the head chip 22 of the print head 21-n displaces corresponding to the residual vibration generated at the respective discharge portions 600-1 to 600-m. The piezoelectric element 60 provided at each of the discharge portions 600-1 to 600-m of the print head 21-n outputs the residual vibration signals Vout-1 to Vout-m corresponding to the displacement. The residual vibration signals Vout-1 to Vout-m are received by the drive signal selection circuit 200 of the print head 21-n. Then, the drive signal selection circuit 200 of the print head 21-n generates the residual vibration detection signal NVT corresponding to the received residual vibration signals Vout-1 to Vout-m, and outputs the residual vibration detection signal NVT from the print head 21-n.

Such a drive signal selection circuit 200 of the print head 21-n is implemented as an integrated circuit apparatus, and may be COF-mounted at the flexible board 24 of the print head 21-n.

The waveform information output circuits 270-1 to 270-n are mounted at the head circuit board 23.

The residual vibration detection signal NVT output from the print head 21-1 is received by the waveform information output circuit 270-1. The waveform information output circuit 270-1 acquires waveform information on the received residual vibration detection signal NVT and generates the waveform information signal WFS1 including the acquired waveform information.

Specifically, the waveform information output circuit 270-1 compares a voltage value of the received residual vibration detection signal NVT with a predetermined reference voltage value, thereby acquiring a cycle of the residual vibration detection signal NVT as the waveform information on the received residual vibration detection signal NVT. The waveform information output circuit 270-1 also estimates and acquires, based on the acquired cycle of the residual vibration detection signal NVT, amplitude of the received residual vibration detection signal NVT as the waveform information on the received residual vibration detection signal NVT. The waveform information output circuit 270-1 may acquire the cycle and the amplitude of the residual vibration detection signal NVT as the waveform information on the received residual vibration detection signal NVT by performing analog-digital conversion on the received residual vibration detection signal NVT. Instead of or in addition to the cycle and the amplitude of the residual vibration detection signal NVT, the waveform information output circuit 270-1 may acquire frequency and a damping ratio of the amplitude as the waveform information. Then, the waveform information output circuit 270-1 generates the waveform information signal WFS1 including the acquired waveform information, and outputs the generated waveform information signal WFS1 to the control circuit 100 of the drive module 10.

Similarly, the residual vibration detection signal NVT output from the print head 21-n is received by the waveform information output circuit 270-n. The waveform information output circuit 270-n acquires the waveform information on the received residual vibration detection signal NVT and generates the waveform information signal WFSn including the acquired waveform information.

Specifically, the waveform information output circuit 270-n compares the voltage value of the received residual vibration detection signal NVT with the predetermined reference voltage value, thereby acquiring the cycle of the residual vibration detection signal NVT as the waveform information on the received residual vibration detection signal NVT. The waveform information output circuit 270-n also acquires, based on the acquired cycle of the residual vibration detection signal NVT, the amplitude of the received residual vibration detection signal NVT as the waveform information on the received residual vibration detection signal NVT. The waveform information output circuit 270-n may acquire the cycle and the amplitude of the residual vibration detection signal NVT as the waveform information on the received residual vibration detection signal NVT by performing analog-digital conversion on the received residual vibration detection signal NVT. The waveform information output circuit 270-n may acquire the frequency and the damping ratio of the amplitude of the residual vibration detection signal NVT as the waveform information. Then, the waveform information output circuit 270-n generates the waveform information signal WFSn including the acquired waveform information, and outputs the generated waveform information signal WFSn to the control circuit 100 of the drive module 10.

The control circuit 100 determines whether a discharge state of ink from each of the print heads 21-1 to 21-n is normal based on the received waveform information signals WFS1 to WFSn.

Here, the waveform information output circuits 270-1 to 270-n may be implemented as one integrated circuit apparatus, or may be implemented by discrete components. The waveform information output circuit 270-1 may be mounted together with the drive signal selection circuit 200 at the integrated circuit apparatus constituting the drive signal selection circuit 200 of the print head 21-1, and the waveform information output circuit 270-n may be mounted together with the drive signal selection circuit 200 at the integrated circuit apparatus constituting the drive signal selection circuit 200 of the print head 21-n.

As described above, the liquid discharge apparatus 1 in the embodiment, that is, the discharge unit 5 includes the drive circuit 50 that outputs the drive voltage signal COM, and the control circuit 100 that determines the discharge state of ink from the print head 21 based on the residual vibration detection signal NVT.

Here, the print heads 21-1 to 21-n have substantially the same configuration, and may be simply referred to as a print head 21 when there is no need to distinguish the print heads 21-1 to 21-n from one another. The description will be presented assuming that the print head 21 receives the clock signal SCK, the latch signal LAT, the change signal CH, the test timing signal TSIG, a print data signal SI as the print data signals SI1 to SIn, the drive voltage signal COM, the reference voltage signal VBS, and the voltage signal VHV, and outputs the residual vibration detection signal NVT. The description will be presented assuming that the residual vibration detection signal NVT output from the print head 21 is received by a waveform information output circuit 270 as the waveform information output circuits 270-1 to 270-n, the waveform information output circuit 270 acquires the waveform information on the received residual vibration detection signal NVT, generates, based on the acquired waveform information, a waveform information signal WFS as the waveform information signals WFS1 to WFSn, and outputs the waveform information signal WFS to the control circuit 100 of the drive module 10.

The discharge portions 600-1 to 600-m of the print head 21 have the same configuration, and are simply referred to as a discharge portion 600 when there is no need to distinguish the discharge portions 600-1 to 600-m from one another. That is, the description will be presented assuming that the print head 21 includes a plurality of discharge portions 600, that is, m discharge portions 600. At this time, the description will be presented assuming that a drive voltage signal Vin as the drive voltage signals Vin-1 to Vin-m is supplied to the discharge portion 600, and the discharge portion 600 outputs a residual vibration signal Vout as the residual vibration signals Vout-1 to Vout-m.

### 1.2 Configuration of Discharge Portion

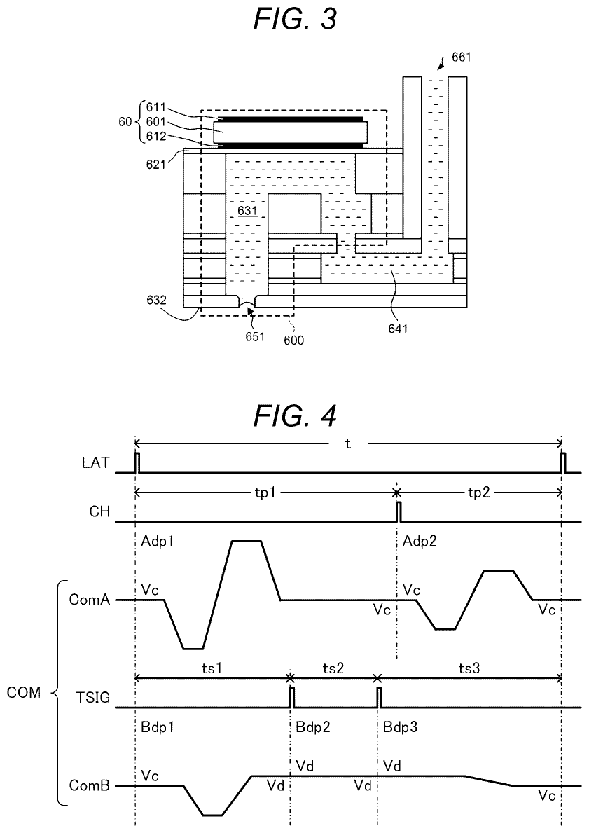

Next, an example of a configuration of the discharge portion 600 of the head chip 22 of the print head 21 will be described. FIG. 3 shows a schematic configuration of the discharge portion 600. FIG. 3 shows a nozzle plate 632, a reservoir 641, and a supply port 661 in addition to the discharge portion 600.

As shown in FIG. 3, the discharge portion 600 includes the piezoelectric element 60, a vibration plate 621, a pressure chamber 631, and a nozzle 651. The piezoelectric element 60 includes a piezoelectric body 601 and electrodes 611 and 612. The piezoelectric element 60 is formed by providing the electrodes 611 and 612 with the piezoelectric body 601 interposed therebetween. Such a piezoelectric element 60 is driven such that a central portion displaces in a vertical direction according to a potential difference between a voltage supplied to the electrode 611 and a voltage supplied to the electrode 612. For example, the drive voltage signal Vin based on the drive voltage signal COM is supplied to the electrode 611, and the reference voltage signal VBS is supplied to the electrode 612. When a voltage value of the drive voltage signal Vin supplied to the electrode 611 changes, the potential difference between the drive voltage signal Vin supplied to the electrode 611 and the reference voltage signal VBS supplied to the electrode 612 changes. As a result, the piezoelectric element 60 is driven such that the central portion thereof displaces in the vertical direction. The drive voltage signal Vin based on the drive voltage signal COM may be supplied to the electrode 612, and the reference voltage signal VBS may be supplied to the electrode 611.

The vibration plate 621 is located below the piezoelectric element 60 in FIG. 3. In other words, the piezoelectric element 60 is formed at an upper surface of the vibration plate 621 in FIG. 3. Such a vibration plate 621 displaces in the vertical direction due to the drive of the piezoelectric element 60 in the vertical direction.

The pressure chamber 631 is located below the vibration plate 621 in FIG. 3. Ink is supplied to the pressure chamber 631 from the reservoir 641. The ink stored in the liquid container 3 is introduced into the reservoir 641 via the supply port 661. That is, the inside of the pressure chamber 631 is filled with the ink stored in the liquid container 3. Internal volume of such a pressure chamber 631 expands or contracts along with the displacement of the vibration plate 621 in the vertical direction. That is, pressure in the pressure chamber 631 changes along with the displacement of the vibration plate 621 in the vertical direction, and at this time, the vibration plate 621 functions as a diaphragm that changes the internal volume of the pressure chamber 631.

The nozzle 651 is an opening provided at the nozzle plate 632 and communicates with the pressure chamber 631. When the internal volume of the pressure chamber 631 changes, ink that fills the inside of the pressure chamber 631 is discharged from the nozzle 651 according to the change in the internal volume.

In the discharge portion 600 implemented as described above, when the piezoelectric element 60 is driven to bend upward, the vibration plate 621 displaces upward. Accordingly, the internal volume of the pressure chamber 631 expands, and as a result, the ink stored in the reservoir 641 is drawn into the pressure chamber 631. On the other hand, when the piezoelectric element 60 is driven to bend downward, the vibration plate 621 displaces downward. Accordingly, the internal volume of the pressure chamber 631 contracts, and as a result, an amount of ink corresponding to a degree of the contraction of the internal volume of the pressure chamber 631 is discharged from the nozzle 651.

After the piezoelectric element 60 is driven to be bent downward, a damped vibration occurs at the pressure chamber 631. Due to the damped vibration generated at the pressure chamber 631, the vibration plate 621 vibrates, and the piezoelectric element 60 also vibrates. When the piezoelectric element 60 vibrates according to the vibration of the vibration plate 621, the piezoelectric element 60 outputs the residual vibration signal Vout based on electric charge generated according to the vibration.

That is, the discharge portion 600 of the print head 21 of the liquid discharge apparatus 1 in the embodiment includes the pressure chamber 631 whose volume changes according to the drive voltage signal COM, the nozzle 651 that communicates with the pressure chamber 631 and discharges ink, and the piezoelectric element 60 that outputs the residual vibration signal Vout corresponding to the residual vibration caused by the change in the volume of the pressure chamber 631. At this time, the piezoelectric element 60 displaces according to the drive voltage signal COM, and the volume of the pressure chamber 631 changes according to the displacement of the piezoelectric element 60.

The structure of the piezoelectric element 60 is not limited to that shown in FIG. 3 as long as the piezoelectric element 60 is driven by supplying the drive voltage signal Vin corresponding to the drive voltage signal COM and the ink can be discharged from the nozzle 651 by being driven in the structure.

### 1.3 Configuration and Operation of Drive Signal Selection Circuit

### 1.3.1 Signal Waveform of Drive Voltage Signal COM

Next, a configuration and an operation of the drive signal selection circuit 200, which generates the corresponding drive voltage signal Vin for each of the plurality of discharge portions 600 of the print head 21 by selecting or deselecting the signal waveform contained in the drive voltage signal COM and outputs the drive voltage signal Vin thereto, will be described. When describing details of the drive signal selection circuit 200, an example of the signal waveform of the drive voltage signal COM received by the drive signal selection circuit 200 will be described. FIG. 4 shows the example of the signal waveform of the drive voltage signal COM. As shown in FIG. 4, the drive voltage signal COM includes a drive voltage signal ComA and a drive voltage signal ComB.

The drive voltage signal ComA includes signal waveforms for representing four gray levels, that is, a large dot LD, a medium dot MD, a small dot SD, and non-recording ND on the medium P. Specifically, the drive voltage signal ComA includes drive waveforms Adp1 and Adp2 as the signal waveforms within a cycle t after a rising edge of the latch signal LAT before a next rising edge of the latch signal LAT.

The drive waveform Adp1 is located within a period tp1 from the rising edge of the latch signal LAT to a rising edge of the change signal CH in the cycle t. A voltage value of the drive waveform Adp1 starts at a voltage Vc, then the voltage value changes to drive the piezoelectric element 60, and then the voltage value ends at the voltage Vc. When the drive waveform Adp1 is supplied to one end of the piezoelectric element 60, a predetermined amount of ink is discharged from the corresponding nozzle 651.

The drive waveform Adp2 is located within a period tp2 from the rising edge of the change signal CH to the rising edge of the latch signal LAT in the cycle t. A voltage value of the drive waveform Adp2 starts at the voltage Vc, then the voltage value changes to drive the piezoelectric element 60, and then the voltage value ends at the voltage Vc. When the drive waveform Adp2 is supplied to the one end of the piezoelectric element 60, an amount of ink smaller than a predetermined amount is discharged from the corresponding nozzle 651.

Here, in the following description, there may be cases in which the predetermined amount of ink discharged from the corresponding nozzle 651 when the drive waveform Adp1 is supplied to the one end of the piezoelectric element 60 is referred to as a medium amount, and the amount of ink smaller than the predetermined amount discharged from the corresponding nozzle 651 when the drive waveform Adp2 is supplied to the one end of the piezoelectric element 60 is referred to as a small amount.

The drive voltage signal ComB includes signal waveforms for performing a state test CD of the nozzle 651 to be tested among a plurality of nozzles 651. Specifically, the drive voltage signal ComB includes drive waveforms Bdp1, Bdp2, and Bdp3 as the signal waveforms within the cycle t.

The drive waveform Bdp1 is located within a period ts1 from the rising edge of the latch signal LAT to a rising edge of the test timing signal TSIG in the cycle t. A voltage value of the drive waveform Bdp1 starts at the voltage Vc, then the voltage value changes to drive the piezoelectric element 60, and then the voltage value ends at a voltage Vd. When the drive waveform Bdp1 is supplied to the one end of the piezoelectric element 60, no ink is discharged from the corresponding nozzle 651, and the piezoelectric element 60 is driven such that a predetermined residual vibration is generated at the corresponding discharge portion 600.

The drive waveform Bdp2 is located within a period ts2 from the rising edge of the test timing signal TSIG defining an end of the period ts1 to a next rising edge of the test timing signal TSIG in the cycle t. A voltage value of the drive waveform Bdp2 is constant at the voltage Vd. When the drive waveform Bdp2 is supplied to the one end of the piezoelectric element 60, the piezoelectric element 60 is not driven, and therefore, no ink is discharged from the corresponding nozzle 651.

A drive waveform Bdp3 is located within a period ts3 from the rising edge of the test timing signal TSIG defining an end of the period ts2 to a next rising edge of the latch signal LAT in the cycle t. A voltage value of the drive waveform Bdp3 starts at the voltage Vd, and then the voltage value ends at the voltage Vc. When the drive waveform Bdp3 is supplied to the one end of the piezoelectric element 60, the piezoelectric element 60 is not driven, and therefore, no ink is discharged from the corresponding nozzle 651.

That is, the drive circuit 50 outputs, to the drive signal selection circuit 200, the drive voltage signal COM that includes the drive voltage signal ComA including the drive waveforms Adp1 and Adp2 for representing the four gray levels, that is, the large dot LD, the medium dot MD, the small dot SD, and the non-recording ND on the medium P, and the drive voltage signal ComB including the drive waveforms Bdp1, Bdp2, and Bdp3 for performing the state test CD of the discharge portion 600 including the nozzle 651 to be tested.

The signal waveform of the drive voltage signal COM shown in FIG. 4 is an example, and the drive voltage signal COM may include signal waveforms of various shapes corresponding to a type of the medium P where the ink is deposited and a characteristic of the ink to be discharged.

### 1.3.2 Configuration of Drive Signal Selection Circuit

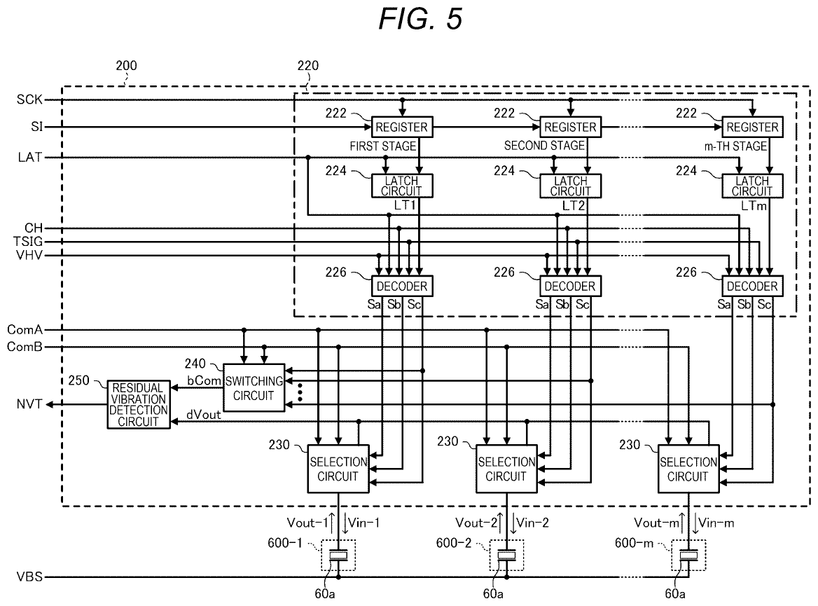

A specific example of the configuration of the drive signal selection circuit 200 will be described. FIG. 5 shows an example of a functional configuration of the drive signal selection circuit 200. In FIG. 5, m discharge portions 600 driven by the drive voltage signal Vin output from the drive signal selection circuit 200 are shown corresponding to the discharge portions 600-1 to 600-m. As shown in FIG. 5, the drive signal selection circuit 200 includes a selection control circuit 220, m selection circuits 230, a switching circuit 240, and a residual vibration detection circuit 250.

The selection control circuit 220 receives the clock signal SCK, the print data signal SI, the latch signal LAT, the change signal CH, the test timing signal TSIG, and the voltage signal VHV. The selection control circuit 220 outputs selection signals Sa, Sb, and Sc at predetermined logic levels during the periods tp1, tp2, ts1, ts2, and ts3 based on the clock signal SCK, the print data signal SI, the latch signal LAT, the change signal CH, the test timing signal TSIG, and the voltage signal VHV thus received.

The selection control circuit 220 includes a set of a register 222, a latch circuit 224, and a decoder 226 provided corresponding to each of the discharge portions 600-1 to 600-m of the print head 21. That is, the selection control circuit 220 includes at least m sets of the register 222, the latch circuit 224, and the decoder 226.

The print data signal SI serially includes, corresponding to each of the m discharge portions 600, 3-bit print data SId [SIH, SIM, SIL] for selecting whether to form any dot of the large dot LD, the medium dot MD, the small dot SD, and the non-recording ND on the medium P, or whether to perform the state test CD for testing the discharge state of the ink from the discharge portion 600. That is, the print data signal SI is a serial signal of 3 m bits or more.

The print data signal SI is received by the selection control circuit 220 in synchronization with the clock signal SCK. The m registers 222 of the selection control circuit 220 retain, corresponding to the discharge portions 600-1 to 600-m, the 3-bit print data SId [SIH, SIM, SIL] contained in the received print data signal SI.

Specifically, the m registers 222 are serially coupled to correspond to the discharge portions 600-1 to 600-m, respectively. The print data signal SI received by the selection control circuit 220 is sequentially transferred to subsequent stages of the m serially-coupled registers 222 in synchronization with the clock signal SCK. That is, the m registers 222 constitute a shift register. When supply of the clock signal SCK to the selection control circuit 220 is stopped, the 3-bit print data SId [SIH, SIM, SIL] corresponding to the discharge portions 600-1 to 600-m is retained in the m registers 222. In the following description, in order to distinguish the m serially-coupled registers 222 from one another, the m registers 222 may be referred to as a first stage, a second stage, . . . , and an m-th stage in this order from upstream to downstream in a direction in which the print data signal SI is supplied.

The m latch circuits 224 latch the 3-bit print data SId [SIH, SIM, SIL] retained in the corresponding registers 222 simultaneously upon the rising edge of the latch signal LAT.

The print data SId [SIH, SIM, SIL] latched by the m latch circuits 224 is received by the respective decoders 226. Each of the m decoders 226 decodes the received print data SId [SIH, SIM, SIL] to generate the selection signals Sa, Sb, and Sc at the logic levels corresponding to the large dot LD, the medium dot MD, the small dot SD, the non-recording ND, and the state test CD.

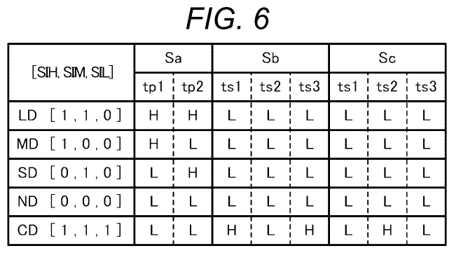

FIG. 6 shows an example of decoded contents in the decoder 226. As shown in FIG. 6, when the print data SId [SIH, SIM, SIL]=[1, 1, 0] corresponding to the large dot LD is received, the decoder 226 sets the logic level of the selection signal Sa to H and H levels during the periods tp1 and tp2, sets the logic level of the selection signal Sb to L, L, and L levels during the periods ts1, ts2, and ts3, and sets the logic level of the selection signal Sc to L, L, and L levels during the periods ts1, ts2, and ts3.

When the print data SId [SIH, SIM, SIL]=[1, 0, 0] corresponding to the medium dot MD is received, the decoder 226 sets the logic level of the selection signal Sa to H and L levels during the periods tp1 and tp2, sets the logic level of the selection signal Sb to L, L, and L levels during the periods ts1, ts2, and ts3, and sets the logic level of the selection signal Sc to L, L, and L levels during the periods ts1, ts2, and ts3.

When the print data SId [SIH, SIM, SIL]=[0, 1, 0] corresponding to the small dot SD is received, the decoder 226 sets the logic level of the selection signal Sa to L and H levels during the periods tp1 and tp2, sets the logic level of the selection signal Sb to L, L, and L levels during the periods ts1, ts2, and ts3, and sets the logic level of the selection signal Sc to L, L, and L levels during the periods ts1, ts2, and ts3.

When the print data SId [SIH, SIM, SIL]=[0, 0, 0] corresponding to the non-recording ND is received, the decoder 226 sets the logic level of the selection signal Sa to L and L levels during the periods tp1 and tp2, sets the logic level of the selection signal Sb to L, L, and L levels during the periods ts1, ts2, and ts3, and sets the logic level of the selection signal Sc to L, L, and L levels during the periods ts1, ts2, and ts3.

When the print data SId [SIH, SIM, SIL]=[1, 1, 1] corresponding to the state test CD is received, the decoder 226 sets the logic level of the selection signal Sa to L and L levels during the periods tp1 and tp2, sets the logic level of the selection signal Sb to H, L, and H levels during the periods ts1, ts2, and ts3, and sets the logic level of the selection signal Sc to L, H, and L levels during the periods ts1, ts2, and ts3.

As described above, the decoder 226 generates, based on the print data SId [SIH, SIM, SIL], the selection signals Sa, Sb, Sc at the logic levels corresponding to the amount of ink to be discharged from the corresponding discharge portion 600. At this time, the selection signals Sa, Sb, and Sc output 1 from the decoder 226 are high-amplitude logic signals that are level-shifted in a level shifter (not shown), and are signals obtained by level-shifting the L level to the ground potential and the H level to the voltage value of the voltage signal VHV.

The selection control circuit 220 outputs the selection signals Sa, Sb, and Sc output from the decoder 226 to the corresponding selection circuit 230, and outputs the selection signal Sc output from the decoder 226 to the switching circuit 240.

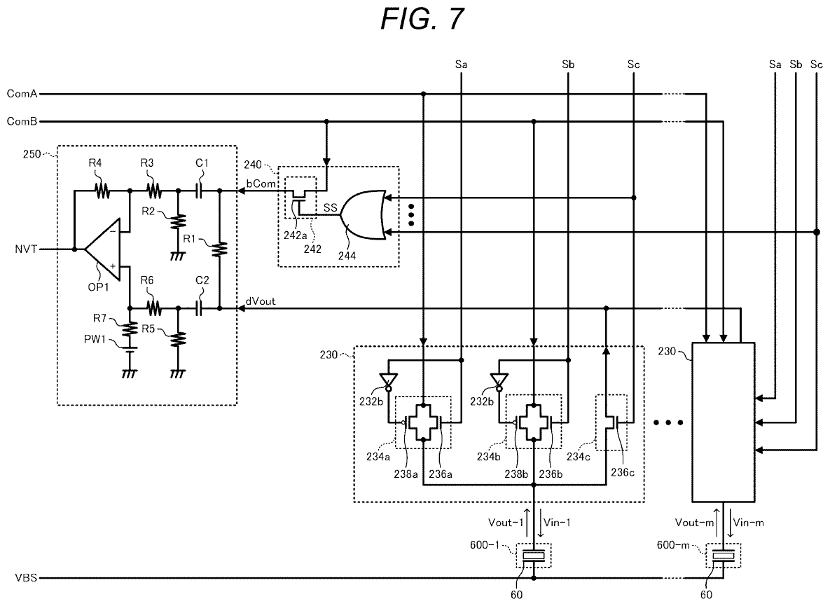

FIG. 7 shows an example of circuit configurations of the selection circuit 230, the switching circuit 240, and the residual vibration detection circuit 250 of the drive signal selection circuit 200. The drive signal selection circuit 200 includes the m selection circuits 230 corresponding to m piezoelectric elements 60, respectively. Here, all of the m selection circuits 230 have the same configuration, and in FIG. 7, only a circuit configuration of the selection circuit 230 corresponding to the discharge portion 600-1 is shown, and circuit configurations of the selection circuits 230 corresponding to the other discharge portions 600 are not shown.

The selection circuit 230 includes logic inversion circuits 232a and 232b, and switch circuits 234a, 234b, and 234c.

The switch circuit 234a includes an n-type transistor 236a and a p-type transistor 238a. One end of the n-type transistor 236a is electrically coupled to one end of the p-type transistor 238a, and the other end of the n-type transistor 236a is electrically coupled to the other end of the p-type transistor 238a. The drive voltage signal ComA is supplied to a coupling point where the one end of the n-type transistor 236a and the one end of the p-type transistor 238a are electrically coupled, and a coupling point where the other end of the n-type transistor 236a and the other end of the p-type transistor 238a are electrically coupled is electrically coupled to the one end of the piezoelectric element 60 provided at the discharge portion 600-1. The selection signal Sa is supplied to a gate terminal that is a control terminal of the n-type transistor 236a, and a signal obtained by inverting the logic level of the selection signal Sa with the logic inversion circuit 232a is supplied to a gate terminal that is a control terminal of the p-type transistor 238a. That is, the switch circuit 234a constitutes a transmission gate.

Here, in the following description, the coupling point where the one end of the n-type transistor 236a and the one end of the p-type transistor 238a are electrically coupled may be referred to as one end of the switch circuit 234a, and the coupling point where the other end of the n-type transistor 236a and the other end of the p-type transistor 238a are electrically coupled may be referred to as the other end of the switch circuit 234a.

When the switch circuit 234a implemented as described above receives the selection signal Sa at the H level, the one end and the other end are controlled to be conductive. As a result, the switch circuit 234a supplies the drive voltage signal ComA to the one end of the piezoelectric element 60. On the other hand, when the switch circuit 234a receives the selection signal Sa at the L level, the one end and the other end are controlled to be non-conductive. As a result, the switch circuit 234a does not supply the drive voltage signal ComA to the one end of the piezoelectric element 60. That is, the switch circuit 234a switches whether to supply the drive voltage signal ComA to the piezoelectric element 60 based on the logic level of the selection signal Sa.

The switch circuit 234b includes an n-type transistor 236b and a p-type transistor 238b. One end of the n-type transistor 236b is electrically coupled to one end of the p-type transistor 238b, and the other end of the n-type transistor 236b is electrically coupled to the other end of the p-type transistor 238b. The drive voltage signal ComB is supplied to a coupling point where the one end of the n-type transistor 236b and the one end of the p-type transistor 238b are electrically coupled, and a coupling point where the other end of the n-type transistor 236b and the other end of the p-type transistor 238b are electrically coupled is electrically coupled to the one end of the piezoelectric element 60 provided at the discharge portion 600-1. The selection signal Sb is supplied to a gate terminal that is a control terminal of the n-type transistor 236b, and a signal obtained by inverting the logic level of the selection signal Sb with the logic inversion circuit 232b is supplied to a gate terminal that is a control terminal of the p-type transistor 238b. That is, the switch circuit 234b constitutes a transmission gate.

Here, in the following description, the coupling point where the one end of the n-type transistor 236b and the one end of the p-type transistor 238b are electrically coupled may be referred to as one end of the switch circuit 234b, and the coupling point where the other end of the n-type transistor 236b and the other end of the p-type transistor 238b are electrically coupled may be referred to as the other end of the switch circuit 234b.

When the switch circuit 234b implemented as described above receives the selection signal Sb at the H level, the one end and the other end are controlled to be conductive. As a result, the switch circuit 234b supplies the drive voltage signal ComB to the one end of the piezoelectric element 60. On the other hand, when the switch circuit 234b receives the selection signal Sb at the L level, the one end and the other end are controlled to be non-conductive. As a result, the switch circuit 234b does not supply the drive voltage signal ComB to the one end of the piezoelectric element 60. That is, the switch circuit 234b switches whether to supply the drive voltage signal ComB to the piezoelectric element 60 based on the logic level of the selection signal Sb.

The switch circuit 234c includes an n-type transistor 236c. One end of the n-type transistor 236c is electrically coupled to one end of the residual vibration detection circuit 250, and the other end of the n-type transistor 236c is electrically coupled to the one end of the piezoelectric element 60 provided at the discharge portion 600-1. The selection signal Sc is supplied to a gate terminal that is a control terminal of the n-type transistor 236b. Here, in the following description, the one end of the n-type transistor 236c may be referred to as the one end of the switch circuit 234b, and the other end of the n-type transistor 236c may be referred to as the other end of the switch circuit 234b.

When the switch circuit 234c implemented as described above receives the selection signal Sc at the H level, the one end and the other end are controlled to be conductive. As a result, the switch circuit 234c outputs, to the residual vibration detection circuit 250, the residual vibration signal Vout-1 output from the piezoelectric element 60 provided at the discharge portion 600-1. On the other hand, when the switch circuit 234c receives the selection signal Sc at the L level, the one end and the other end are controlled to be non-conductive. As a result, the switch circuit 234c does not output, to the residual vibration detection circuit 250, the residual vibration signal Vout-1 output from the piezoelectric element 60 provided at the discharge portion 600-1. That is, the switch circuit 234c switches whether to output the residual vibration signal Vout to the residual vibration detection circuit 250.

Here, the other ends of switch circuits 234c of the m selection circuits 230 corresponding to the discharge portions 600-1 to 600-m, respectively, are commonly coupled and then electrically coupled to the residual vibration detection circuit 250. In other words, the residual vibration signals Vout-1 to Vout-m output from the m selection circuits 230 corresponding to the discharge portions 600-1 to 600-m, respectively, are propagated through a common wiring pattern and are received by the residual vibration detection circuit 250. In the following description, the residual vibration signals Vout-1 to Vout-m received by the residual vibration detection circuit 250 may be referred to as a residual vibration signal dVout.

The selection circuit 230 implemented as described above selects or deselects the signal waveforms of the drive voltage signals ComA and ComB based on the selection signals Sa and Sb, thereby generating the drive voltage signal Vin and supplying the drive voltage signal Vin to the one end of the piezoelectric element 60, and also switches whether to acquire the residual vibration signal Vout generated at the corresponding discharge portion 600 based on the selection signal Sc. Here, in the following description, a state in which the one end and the other end of the switch circuit 234a are controlled to be conductive, a state in which the one end and the other end of the switch circuit 234b are controlled to be conductive, and a state in which the one end and the other end of the switch circuit 234c are controlled to be conductive may be referred to as “ON”, a state in which the one end and the other end of the switch circuit 234a are controlled to be non-conductive, a state in which the one end and the other end of the switch circuit 234b are controlled to be non-conductive, and a state in which the one end and the other end of the switch circuit 234c are controlled to be non-conductive may be referred to as “OFF”.

That is, the selection circuit 230 includes the switch circuit 234a that switches whether to supply the drive voltage signal ComA to the one end of the piezoelectric element 60 provided at the discharge portion 600, the switch circuit 234b that switches whether to supply the drive voltage signal ComB to the one end of the piezoelectric element 60 provided at the discharge portion 600, and the switch circuit 234c that switches whether to supply the residual vibration signal Vout output from the piezoelectric element 60 of the discharge portion 600 to the residual vibration detection circuit 250. At this time, in the liquid discharge apparatus 1 in the embodiment, the switch circuit 234a is a transmission gate including the n-type transistor 236a that is an N-channel type transistor and the p-type transistor 238a that is a P-channel type transistor, the switch circuit 234b is a transmission gate including the n-type transistor 236b that is an N-channel type transistor and the p-type transistor 238b that is a P-channel type transistor, and the switch circuit 234c includes the n-type transistor 236c that is an N-channel type transistor.

In other words, the selection circuit 230 includes the n-type transistor 236a and the p-type transistor 238a for switching whether to supply the drive voltage signal ComA to the one end of the piezoelectric element 60 provided at the discharge portion 600, the n-type transistor 236b and the p-type transistor 238b for switching whether to supply the drive voltage signal ComB to the one end of the piezoelectric element 60 provided at the discharge portion 600, and the n-type transistor 236c for switching whether to supply, to the residual vibration detection circuit 250, the residual vibration signal Vout output from the piezoelectric element 60 of the discharge portion 600.

The switching circuit 240 includes a switch circuit 242 and an OR circuit 244. The switch circuit 242 includes an n-type transistor 242a.

The OR circuit 244 receives the selection signal Sc output from the decoder 226 corresponding to each of the discharge portions 600-1 to 600-m. In addition, the OR circuit 244 outputs a switch control signal SS to a gate terminal that is a control terminal of the n-type transistor 242a. One end of the n-type transistor 242a is electrically coupled to a wiring pattern through which the drive voltage signal ComB is propagated, and the other end thereof is electrically coupled to the residual vibration detection circuit 250.

In the switching circuit 240 implemented as described above, when any one selection signal Sc output from the decoder 226 corresponding to each of the discharge portions 600-1 to 600-m is at the H level, the OR circuit 244 outputs the switch control signal SS at the H level, and when the switch control signal SS at the H level is received from the switching circuit 240, the n-type transistor 242a is controlled to be conductive between the one end and the other end. As a result, the switching circuit 240 treats the drive voltage signal ComB as a drive voltage signal bCom and outputs the drive voltage signal bCom to the residual vibration detection circuit 250.

That is, the switching circuit 240 switches whether to output the drive voltage signal ComB as the drive voltage signal bCom to the residual vibration detection circuit 250 according to the logic level of the selection signal Sc. In other words, the switching circuit 240 includes the n-type transistor 242a that is an N-channel type transistor for switching whether to supply the drive voltage signal ComB to the residual vibration detection circuit 250.

The residual vibration detection circuit 250 includes resistors R1, R2, R3, R4, R5, R6, and R7, capacitors C1 and C2, a power supply circuit PW1, and an amplifier circuit OP1.

The drive voltage signal bCom output from the switching circuit 240 is supplied to one end of the resistor R1, and the residual vibration signal dVout output from the m selection circuits 230 is supplied to the other end of the resistor R2.

One end of the capacitor C1 is electrically coupled to the one end of the resistor R1. The other end of the capacitor C1 is electrically coupled to one end of the resistor R2. The ground potential is supplied to the other end of the resistor R2. That is, the capacitor C1 and the resistor R2 form a high-pass filter circuit. Output of the high-pass filter circuit formed of the capacitor C1 and resistor R2, that is, the other end of the capacitor C1 and the one end of the resistor R2, are electrically coupled to one end of the resistor R3. The other end of the resistor R3 is electrically coupled to one end of the resistor R4, and is electrically coupled to a negative-side input terminal of the amplifier circuit OP1. The other end of the resistor R4 is electrically coupled to an output terminal of the amplifier circuit OP1.

The other end of the resistor R1 is electrically coupled to one end of the capacitor C2. The other end of the capacitor C2 is electrically coupled to one end of the resistor R5. The ground potential is supplied to the other end of the resistor R5. That is, the capacitor C2 and the resistor R5 form a high-pass filter circuit. Output of the high-pass filter circuit formed of the capacitor C2 and resistor R5, that is, the other end of the capacitor C2 and the one end of the resistor R5, are electrically coupled to one end of the resistor R6. The other end of the resistor R6 is electrically coupled to one end of the resistor R7, and is electrically coupled to a positive-side input terminal of the amplifier circuit OP1. The other end of the resistor R7 is electrically coupled to a positive terminal of the power supply circuit PW1, and the ground potential is supplied to a negative terminal of the power supply circuit PW1.

In the residual vibration detection circuit 250 implemented as described above, a signal in which a DC component of the drive voltage signal bCom is reduced by the high-pass filter circuit including the capacitor C1 and the resistor R2 is received by the negative-side input terminal of the amplifier circuit OP1, and a signal obtained by superimposing a bias voltage signal VB output from the power supply circuit PW1 on a signal in which a DC component contained in the residual vibration signal dVout is reduced by the high-pass filter circuit including the capacitor C2 and the resistor R4 is received by the positive-side input terminal of the amplifier circuit OP1. The amplifier circuit OP1 outputs, as the residual vibration detection signal NVT, a signal obtained by adding a voltage vb, which is a voltage value of the bias voltage signal VB, to a signal obtained by amplifying a difference between the signal received by the negative-side input terminal and the signal received by the positive-side input terminal with an amplification factor defined by a resistance value of the resistor R4 and a resistance value of the resistor R3. That is, the residual vibration detection circuit 250 outputs a signal corresponding to a difference between the drive voltage signal bCom and the residual vibration signal dVout, that is, a signal according to a potential difference between two ends of the resistor R1, as the residual vibration detection signal NVT.

That is, the residual vibration detection circuit 250 includes the resistor R1, which has one end electrically coupled to the one end of the n-type transistor 236c and the other end electrically coupled to the one end of the n-type transistor 242a, and the amplifier circuit OP1 for amplifying the potential difference between the one end and the other end of the resistor R1, and outputs the residual vibration detection signal NVT corresponding to the received residual vibration signal Vout, that is, the residual vibration detection signal NVT corresponding to the difference between the residual vibration signal Vout received via the n-type transistor 236c and the drive voltage signal ComB received via the n-type transistor 242a.

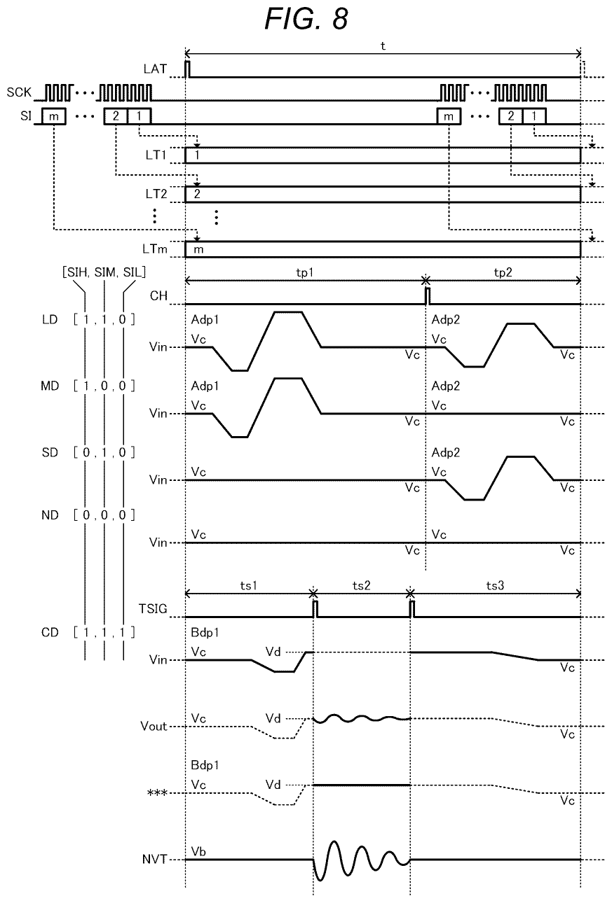

Details of the operation of the drive signal selection circuit 200 implemented as described above will be described. FIG. 8 shows an example of the operation of the drive signal selection circuit 200. The print data signal SI is serially supplied to the drive signal selection circuit 200 in synchronization with the clock signal SCK. The print data signal SI received by the drive signal selection circuit 200 is sequentially transferred to the registers 222 of the subsequent stages in synchronization with the clock signal SCK. Then, when the supply of the clock signal SCK to the drive signal selection circuit 200 is stopped, the 3-bit print data SId [SIH, SIM, SIL] corresponding to the m discharge portions 600 is retained in the m registers 222.

Thereafter, when the latch signal LAT rises, the latch circuits 224 simultaneously latch the print data SId [SIH, SIM, SIL] retained in the registers 222. Here, LT1, LT2, . . . , LTm shown in FIG. 8 represent the print data SId [SIH, SIM, SIL] retained by the registers 222 of the first stage, the second stage, . . . , and the m-th stage and latched by the corresponding latch circuits 224.

The print data SId [SIH, SIM, SIL] latched by each latch circuit 224 is received by the decoder 226. The decoder 226 decodes the received print data SId [SIH, SIM, SIL] based on contents shown in FIG. 6 to output the selection signals Sa, Sb, Sc at predetermined logic levels in the cycle t.

Specifically, when the print data SId [SIH, SIM, SIL]=[1, 1, 0] is received, the decoder 226 sets the logic level of the selection signal Sa to H and H levels during the periods tp1 and tp2, sets the logic level of the selection signal Sb to L, L, and L levels during the periods ts1, ts2, and ts3, and sets the logic level of the selection signal Sc to L, L, and L levels during the periods ts1, ts2, and ts3. Accordingly, during the period tp1, the switch circuit 234a is controlled to be ON, the switch circuit 234b is controlled to be OFF, and the switch circuit 234c is controlled to be OFF. Therefore, during the period tp1, the selection circuit 230 selects the drive waveform Adp1 and outputs the selected drive waveform Adp1 as the drive voltage signal Vin. During the period tp2, the switch circuit 234a is controlled to be ON, the switch circuit 234b is controlled to be OFF, and the switch circuit 234c is controlled to be OFF. Therefore, during the period tp2, the selection circuit 230 selects the drive waveform Adp2 and outputs the selected drive waveform Adp2 as the drive voltage signal Vin.

That is, when the print data SId [SIH, SIM, SIL]=[1, 1, 0] is received by the decoder 226, the corresponding selection circuit 230 supplies, to the piezoelectric element 60 provided at the corresponding discharge portion 600, the drive voltage signal Vin corresponding to the large dot LD shown in FIG. 8, that is, the drive voltage signal Vin in which the drive waveform Adp1 and the drive waveform Adp2 are continuous in the cycle t. Accordingly, a medium amount of ink is discharged during the period tp1 from the nozzle 651 provided at the corresponding discharge portion 600, and a small amount of ink is discharged during the period tp2. As a result, in the cycle t, the medium amount of ink and the small amount of ink are deposited on the medium P and combined to form the large dot LD on the medium P.

When the print data SId [SIH, SIM, SIL]=[1, 0, 0] is received, the decoder 226 sets the logic level of the selection signal Sa to H and L levels during the periods tp1 and tp2, sets the logic level of the selection signal Sb to L, L, and L levels during the periods ts1, ts2, and ts3, and sets the logic level of the selection signal Sc to L, L, and L levels during the periods ts1, ts2, and ts3. Accordingly, during the period tp1, the switch circuit 234a is controlled to be ON, the switch circuit 234b is controlled to be OFF, and the switch circuit 234c is controlled to be OFF. Therefore, during the period tp1, the selection circuit 230 selects the drive waveform Adp1 and outputs the selected drive waveform Adp1 as the drive voltage signal Vin. During the period tp2, the switch circuit 234a is controlled to be OFF, the switch circuit 234b is controlled to be OFF, and the switch circuit 234c is controlled to be OFF. Therefore, during the period tp2, the selection circuit 230 does not select any of the drive waveforms Adp1, Adp2, Bdp1, Bdp2, and Bdp3. At this time, the voltage Vc held by a capacitive component of the piezoelectric element 60 is supplied to the corresponding piezoelectric element 60.

That is, when the print data SId [SIH, SIM, SIL]=[1, 0, 0] is received by the decoder 226, the corresponding selection circuit 230 supplies, to the piezoelectric element 60 provided at the corresponding discharge portion 600, the drive voltage signal Vin corresponding to the medium dot MD shown in FIG. 8, that is, the drive voltage signal Vin in which the drive waveform Adp1 and a signal waveform having a constant voltage value of the voltage Vc are continuous in the cycle t. Accordingly, a medium amount of ink is discharged during the period tp1 from the nozzle 651 provided at the corresponding discharge portion 600, and no ink is discharged during the period tp2. As a result, in the cycle t, the medium amount of ink is deposited on the medium P, and the medium dot MD is formed on the medium P.

When the print data SId [SIH, SIM, SIL]=[0, 1, 0] is received, the decoder 226 sets the logic level of the selection signal Sa to L and H levels during the periods tp1 and tp2, sets the logic level of the selection signal Sb to L, L, and L levels during the periods ts1, ts2, and ts3, and sets the logic level of the selection signal Sc to L, L, and L levels during the periods ts1, ts2, and ts3. Accordingly, during the period tp1, the switch circuit 234a is controlled to be OFF, the switch circuit 234b is controlled to be OFF, and the switch circuit 234c is controlled to be OFF. Therefore, during the period tp1, the selection circuit 230 does not select any of the drive waveforms Adp1, Adp2, Bdp1, Bdp2, and Bdp3. At this time, the voltage Vc held by the capacitive component of the piezoelectric element 60 is supplied to the corresponding piezoelectric element 60. During the period tp2, the switch circuit 234a is controlled to be ON, the switch circuit 234b is controlled to be OFF, and the switch circuit 234c is controlled to be OFF. Therefore, during the period tp2, the selection circuit 230 selects the drive waveform Adp2 and outputs the selected drive waveform Adp2 as the drive voltage signal Vin.

That is, when the print data SId [SIH, SIM, SIL]=[0, 1, 0] is received by the decoder 226, the corresponding selection circuit 230 supplies, to the piezoelectric element 60 provided at the corresponding discharge portion 600, the drive voltage signal Vin corresponding to the small dot SD shown in FIG. 8, that is, the drive voltage signal Vin in which a signal waveform having a constant voltage value of the voltage Vc and the drive waveform Adp2 are continuous in the cycle t. Accordingly, no ink is discharged during the period tp1 from the nozzle 651 provided at the corresponding discharge portion 600, and a small amount of ink is discharged during the period tp2. As a result, in the cycle t, the small amount of ink is deposited on the medium P, and the small dot SD is formed on the medium P.

When the print data SId [SIH, SIM, SIL]=[0, 0, 0] is received, the decoder 226 sets the logic level of the selection signal Sa to L and L levels during the periods tp1 and tp2, sets the logic level of the selection signal Sb to L, L, and L levels during the periods ts1, ts2, and ts3, and sets the logic level of the selection signal Sc to L, L, and L levels during the periods ts1, ts2, and ts3. Accordingly, during the period tp1, the switch circuit 234a is controlled to be OFF, the switch circuit 234b is controlled to be OFF, and the switch circuit 234c is controlled to be OFF. Therefore, during the period tp1, the selection circuit 230 does not select any of the drive waveforms Adp1, Adp2, Bdp1, Bdp2, and Bdp3. At this time, the voltage Vc held by the capacitive component of the piezoelectric element 60 is supplied to the corresponding piezoelectric element 60. During the period tp2, the switch circuit 234a is controlled to be OFF, the switch circuit 234b is controlled to be OFF, and the switch circuit 234c is controlled to be OFF. Therefore, during the period tp2, the selection circuit 230 does not select any of the drive waveforms Adp1, Adp2, Bdp1, Bdp2, and Bdp3. At this time, the voltage Vc held by the capacitive component of the piezoelectric element 60 is supplied to the corresponding piezoelectric element 60.

That is, when the print data SId [SIH, SIM, SIL]=[0, 0, 0] is received by the decoder 226, the corresponding selection circuit 230 supplies, to the piezoelectric element 60 provided at the corresponding discharge portion 600, the drive voltage signal Vin corresponding to the non-recording ND shown in FIG. 8, that is, the drive voltage signal Vin having a signal waveform having a constant voltage value of the voltage Vc in the cycle t. Accordingly, no ink is discharged during the period tp1 from the nozzle 651 provided at the corresponding discharge portion 600, and no ink is discharged also during the period tp2. As a result, in the cycle t, no ink is deposited on the medium P, and no dot is formed on the medium P.

When the print data SId [SIH, SIM, SIL]=[1, 1, 1] is received, the decoder 226 sets the logic level of the selection signal Sa to L and L levels during the periods tp1 and tp2, sets the logic level of the selection signal Sb to H, L, and H levels during the periods ts1, ts2, and ts3, and sets the logic level of the selection signal Sc to L, H, and L levels during the periods ts1, ts2, and ts3. Accordingly, during the period ts1, the switch circuit 234a is controlled to be OFF, the switch circuit 234b is controlled to be ON, and the switch circuit 234c is controlled to be OFF. Therefore, during the period ts1, the selection circuit 230 selects the drive waveform Bdp1 and outputs the selected drive waveform Bdp1 as the drive voltage signal Vin. During the period ts2, the switch circuit 234a is controlled to be OFF, the switch circuit 234b is controlled to be OFF, and the switch circuit 234c is controlled to be ON. Therefore, the selection circuit 230 drives the piezoelectric element 60 according to the drive waveform Bdp1 during the period tp2, and then acquires the residual vibration signal Vout corresponding to a residual vibration generated at the corresponding discharge portion 600. During the period ts3, the switch circuit 234a is controlled to be OFF, the switch circuit 234b is controlled to be ON, and the switch is circuit 234c controlled to be OFF. Therefore, during the period ts3, the selection circuit 230 selects the drive waveform Bdp3 and outputs the selected drive waveform Bdp3 as the drive voltage signal Vin.

That is, when the print data SId [SIH, SIM, SIL]=[1, 1, 1] is received by the decoder 226, the corresponding selection circuit 230 supplies, to the piezoelectric element 60, the drive voltage signal Vin for driving the piezoelectric element 60 such that no ink is discharged from the nozzle 651 provided at the corresponding discharge portion 600 and the predetermined residual vibration is generated at the corresponding discharge portion 600 during the period ts1, acquires the residual vibration signal Vout output from the corresponding piezoelectric element 60 during the period ts2, and supplies, to the piezoelectric element 60, the drive voltage signal Vin for bringing displacement of the piezoelectric element 60 into a steady state during the period ts3.

The residual vibration signal Vout corresponding to the residual vibration generated at the corresponding discharge portion 600 acquired during the period ts2 by the selection circuit 230 is output to the residual vibration detection circuit 250 as the residual vibration signal dVout. During the period tp2, the H level selection signal Sc output from the decoder 226 is also received by the switching circuit 240. Accordingly, the switching circuit 240 outputs the drive voltage signal ComB during the period tp2 to the residual vibration detection circuit 250 with the drive waveform Bdp2 serving as the drive voltage signal bCom. Then, the residual vibration detection circuit 250 outputs, as the residual vibration detection signal NVT, the signal obtained by adding the voltage vb that is the voltage value of the bias voltage signal VB to the signal obtained by amplifying the difference between the residual vibration signal dVout and the drive voltage signal bCom.

The residual vibration detection signal NVT output from the residual vibration detection circuit 250 is received by the waveform information output circuit 270. The waveform information output circuit 270 acquires the cycle and the amplitude of the residual vibration detection signal NVT as the waveform information on the input residual vibration detection signal NVT, generates the waveform information signal WFS including the acquired waveform information, and outputs the waveform information signal WFS to the control circuit 100. Based on the waveform information signal WFS including the received waveform information, the control circuit 100 determines the discharge state of ink from the discharge module 20, that is, the discharge state of ink from the discharge portion 600 including the piezoelectric element 60 that outputs the residual vibration signal Vout. That is, when the print data SId [SIH, SIM, SIL]=[1, 1, 1] is received by the decoder 226, the state test CD for testing the discharge state of ink from the corresponding discharge portion 600 is performed.

Here, the residual vibration signal Vout acquired by the selection circuit 230 during the period ts2, that is, the residual vibration signal dVout received by the residual vibration detection circuit 250 during the period ts2 is a signal in which electric charge output from the piezoelectric element 60 corresponding to the residual vibration generated at the corresponding discharge portion 600 is superimposed on the voltage Vd that is the voltage value of the drive waveform Bdp1 supplied to the piezoelectric element 60 immediately before the period ts2, and is a signal in which the drive voltage signal ComB as the drive voltage signal bCom output from the switching circuit 240 is the drive waveform Bdp2 having a constant voltage value at the voltage Vd during the period ts2. That is, the residual vibration detection circuit 250 generates the residual vibration detection signal NVT by extracting and amplifying a signal generated by the electric charge output from the piezoelectric element 60 corresponding to the residual vibration generated at the discharge portion 600 during the period ts2 and adding the voltage vb that is the voltage value of the bias voltage signal VB. In other words, the residual vibration detection circuit 250 shapes the signal waveform of the residual vibration signal Vout output corresponding to the residual vibration generated at the corresponding discharge portion 600, and outputs the residual vibration detection signal NVT corresponding to the residual vibration generated at the discharge portion 600.

Accordingly, in the residual vibration detection circuit 250 in the embodiment, an influence of noise superimposed on the drive voltage signal ComB is reduced. Therefore, accuracy of the residual vibration detection signal NVT output from the residual vibration detection circuit 250 is improved. As a result, determination accuracy of the discharge state of ink from the discharge module 20 in the control circuit 100, that is, determination accuracy of the discharge state of ink from the discharge portion 600 including the piezoelectric element 60 that outputs the residual vibration signal Vout is improved.

As described above, the drive signal selection circuit 200 controls the amount of ink discharged from the corresponding discharge portion 600 for each cycle t based on the logic level of the print data SId [SIH, SIM, SIL] serially contained in the print data signal SI received in synchronization with the clock signal SCK, thereby forming multilevel dots on the medium P, acquiring the residual vibration signal Vout corresponding to the residual vibration generated at the corresponding discharge portion 600, and outputting the residual vibration detection signal NVT corresponding to the acquired residual vibration signal Vout.

Here, it is preferable that a voltage value of the residual vibration signal Vout during the period ts2, that is, a period when the n-type transistor 236c is controlled to be ON and the n-type transistor 236c outputs the residual vibration signal Vout to the residual vibration detection circuit 250 when the selection circuit 230 acquires the residual vibration signal Vout, is smaller than a value obtained by subtracting, from a voltage value of the selection signal Sc received by a gate terminal that is a control terminal of the n-type transistor 236c, a threshold voltage at which the n-type transistor 236c is controlled to be ON, which is a threshold voltage for switching whether the n-type transistor 236c supplies the residual vibration signal Vout to the residual vibration detection circuit 250. That is, it is preferable that a voltage value of the drive voltage signal ComB during the period ts2, which is the voltage Vd that is the voltage value of the drive waveform Bdp2, is smaller than a voltage value obtained by subtracting the threshold voltage of the n-type transistor 236c from the voltage value of the voltage signal VHV that is the voltage value of the selection signal Sc.

A voltage value associated with the electric charge output from the piezoelectric element 60 corresponding to the residual vibration generated at the discharge portion 600, that is, a voltage value associated with the electric charge output from the piezoelectric element 60 in response to the residual vibration generated at the discharge portion 600 and superimposed on the drive waveform Bdp2 is weak, and therefore is easily affected by on-resistance of the n-type transistor 236c when the selection circuit 230 acquires the residual vibration signal Vout. Since the voltage value of the residual vibration signal Vout in the period when the n-type transistor 236c outputs the residual vibration signal Vout to the residual vibration detection circuit 250 is smaller than the value obtained by subtracting, from the voltage value of the selection signal Sc received by the gate terminal that is the control terminal of the n-type transistor 236c, the threshold voltage for switching whether the n-type transistor 236c supplies the residual vibration signal Vout to the residual vibration detection circuit 250, the on-resistance of the N-type transistor 236c can be reduced, and as a result, accuracy of acquiring the residual vibration signal Vout in the selection circuit 230 is improved, and the determination accuracy of the state of the discharge portion 600 is improved.

### 1.3.3 Structure of Drive Signal Selection Circuit

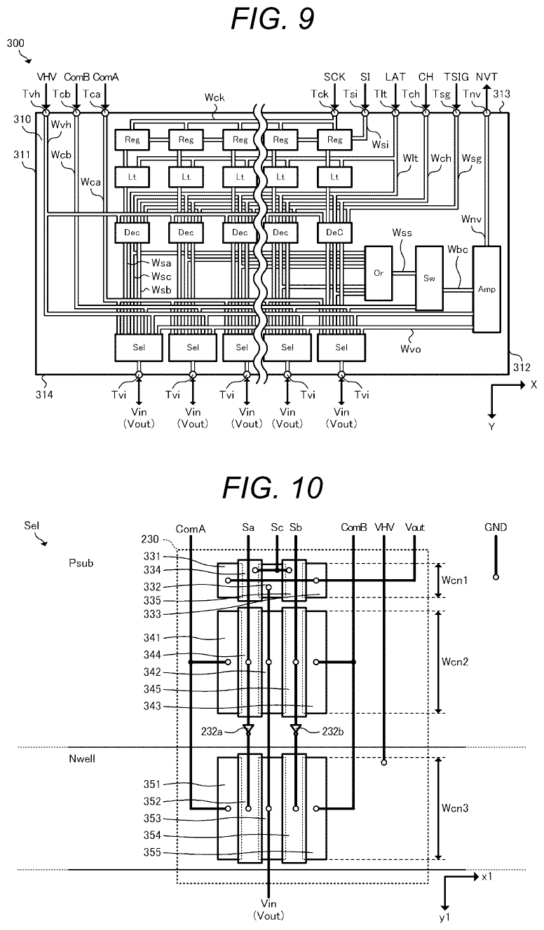

Next, an example of a structure of an integrated circuit 300 that is an integrated circuit apparatus where the drive signal selection circuit 200 is mounted will be described. FIG. 9 shows the example of the structure of an integrated circuit 300. Here, in FIG. 9, description will be presented using an X axis and a Y axis orthogonal to each other. In the description in FIG. 9, a tip side of an arrow indicating the shown X axis is referred to as a +X side and a starting point side is referred to as a −X side, and a tip side of an arrow indicating the shown Y axis is referred to as a +Y side and a starting point side is referred to as a −Y side.

As shown in FIG. 9, the integrated circuit 300 includes a board 310. The board 310 includes short sides 311 and 312 and long sides 313 and 314 longer than the short sides 311 and 312. The short side 311 and the short side 312 face each other along the X axis, with the short side 311 located on the −X side and the short side 312 located on the +X side. The long side 313 and the long side 314 face each other along the Y axis, with the long side 313 located on the −Y side and the long side 314 located on the +Y side. The short side 311 is substantially orthogonal to the long side 313 and the long side 314, and the short side 312 is substantially orthogonal to the long side 313 and the long side 314. That is, the board 310 has a substantially rectangular shape. The shape of the board 310 is not limited to the substantially rectangular shape, and may be a circle or another polygon, and may have a notch, an arc, or an opening.

The board 310 is provided with terminals Tck, Tsi, Tlt, Tch, Tsg, Tnv, Tca, Tcb, Tvh, and m terminals Tvi. The terminals Tck, Tsi, Tlt, Tch, Tsg, Tnv, Tca, Tcb, and Tvh are aligned along the Y axis in the vicinity of the long side 313. Specifically, the terminals Tck, Tsi, Tlt, Tch, Tsg, Tnv, Tca, Tcb, and Tvh are aligned in an order of the terminal Tvh, the terminal Tcb, the terminal Tca, the terminal Tck, the terminal Tsi, the terminal Tlt, the terminal Tch, the terminal Tsg, and the terminal Tnv from the −X side to the +X side along the Y axis. The m terminals Tvi are aligned along the Y axis in the vicinity of the long side 314. In addition to the terminals Tck, Tsi, Tlt, Tch, Tsg, Tnv, Tca, Tcb, Tvh, and the m terminals Tvi, a plurality of terminals such as terminals to which the ground potential is supplied may be provided on the board 310.

The integrated circuit 300 operates according to a signal received via each of the terminals Tck, Tsi, Tlt, Tch, Tsg, Tca, Tcb, and Tvh, and outputs a signal corresponding to the operation from each of the terminal Tnv and the m terminals Tvi. Specifically, the clock signal SCK is supplied to the terminal Tck, the print data signal SI is supplied to the terminal Tsi, the latch signal LAT is supplied to the terminal Tlt, the change signal CH is supplied to the terminal Tch, the test timing signal TSIG is supplied to the terminal Tsg, the drive voltage signal ComA is supplied to the terminal Tca, the drive voltage signal ComB is supplied to the terminal Tcb, and the voltage signal VHV is supplied to the terminal Tvh. The residual vibration detection signal NVT is output from the terminal Tnv. The drive voltage signal Vin is output from each of the m terminals Tvi to the corresponding discharge portion 600, and the residual vibration signal Vout is supplied from the corresponding discharge portion 600 to each of the m terminals Tvi.

The m registers 222, the m latch circuits 224, the m decoders 226, the m selection circuits 230, the switching circuit 240, and the residual vibration detection circuit 250 constituting the drive signal selection circuit 200 are mounted at the board 310. Here, in FIG. 9, a region where each register 222 is mounted is shown as a mounting region Reg, a region where each latch circuit 224 is mounted is shown as a mounting region Lt, a region where each decoder 226 is mounted is shown as a mounting region Dec, a region where each selection circuit 230 is mounted is shown as a mounting region Sel, a region where the OR circuit 244 of the switching circuit 240 is mounted is shown as a mounting region Or, a region where the switch circuit 242 of the switching circuit 240 is mounted is shown as a mounting region Sw, and a region where the residual vibration detection circuit 250 is mounted is shown as a mounting region Amp.

The m mounting regions Reg are aligned along the X axis. The m mounting regions Lt are aligned along the X axis on the +Y side of the m mounting regions Reg aligned along the X axis. The m mounting regions Dec are aligned along the X axis on the +Y side of the m mounting regions Lt aligned along the X axis. The m mounting regions Sel are aligned along the X axis on the +Y side of the m mounting regions Dec aligned along the X axis. That is, the m mounting regions Reg, the m mounting regions Lt, the m mounting regions Dec, and the m mounting regions Sel are located along the Y axis from the −Y side to the +Y side in an order of the m mounting regions Reg, the m mounting regions Lt, the m mounting regions Dec, and the m mounting regions Sel.

An i-th (i is 1 to m) mounting region Reg from the short side 311 side among the m mounting regions Reg, an i-th mounting region Lt from the short side 311 side among the m mounting regions Lt, an i-th mounting region Dec from the short side 311 side among the m mounting regions Dec, and an i-th mounting region Sel from the short side 311 side among the m mounting regions Sel are aligned in an order of the mounting region Reg, the mounting region Lt, the mounting region Dec, and the mounting region Sel from the −Y side toward the +Y side along the Y axis.

The mounting region Or where the OR circuit 244 of the switching circuit 240 is mounted is on the +X side of the m mounting regions Reg, the m mounting regions Lt, the m mounting regions Dec, and the m mounting regions Sel, and at least a portion thereof is located between the mounting regions Dec and the mounting regions Sel when viewed along the X axis. The mounting region Sw where the switch circuit 242 of the switching circuit 240 is mounted is on the +X side of the mounting region Or and at least partially overlaps the mounting region Or when viewed along the X axis. The mounting region Amp where the residual vibration detection circuit 250 is mounted is located on the +X side of the mounting region Sw.

The terminals Tck, Tsi, Tlt, Tch, Tsg, Tnv, Tca, Tcb, Tvh, the m terminals Tvi, the m mounting regions Reg, the m mounting regions Lt, the m mounting regions Dec, the m mounting regions Sel, the mounting region Or, the mounting region Sw, and the mounting region Amp disposed as described above are electrically coupled with a wiring pattern formed at the board 310.

A wiring Wck is electrically coupled to each of the m registers 222 mounted in the m mounting regions Reg. The wiring Wck is also electrically coupled to the terminal Tck. Each of the m registers 222 mounted in the m mounting regions Reg is electrically coupled to a register 222 mounted in an adjacent mounting region Reg via a wiring pattern. That is, the m registers 222 mounted in the m mounting regions Reg are serially coupled. One end of a wiring Wsi is electrically coupled to a register 222 in a mounting region Reg located furthest on the +X side among the m mounting regions Reg aligned along the X axis, and the other end of the wiring Wsi is electrically coupled to the terminal Tsi.

The print data signal SI supplied to the terminal Tsi is propagated through the wiring Wsi and received by the register 222 in the mounting region Reg located furthest on the +X side among the m mounting regions Reg aligned along the X axis. The clock signal SCK supplied to the terminal Tck is propagated through the wiring Wck and received by each of the m registers 222 mounted in the m mounting regions Reg. Accordingly, the print data SId [SIH, SIM, SIL] contained in the print data signal SI is sequentially transferred to the registers 222 of the subsequent stages in synchronization with the clock signal SCK. When the supply of the clock signal SCK to the terminal Tck is stopped, the print data SId [SIH, SIM, SIL] is retained in each of the m registers 222 mounted in the m mounting regions Reg.

A wiring Wlt is electrically coupled to each of the m latch circuits 224 mounted in the m mounting regions Lt. The wiring Wlt is also electrically coupled to the terminal Tlt. Each of the m latch circuits 224 mounted in the m mounting regions Lt is also electrically coupled to the corresponding register 222 via a wiring pattern. Specifically, the register 222 mounted in the i-th mounting region Reg from the short side 311 side among the m mounting regions Reg is electrically coupled via a wiring pattern to the latch circuit 224 mounted in the i-th mounting region Lt from the short side 311 side among the m mounting regions Lt, and the register 222 mounted in an (i+1)-th mounting region Reg from the short side 311 side among the m mounting regions Reg is electrically coupled via a wiring pattern to the latch circuit 224 mounted in an (i+1)-th mounting region Lt from the short side 311 side among the m mounting regions Lt.

The latch signal LAT supplied to the terminal Tlt is propagated through the wiring Wsi and received by each of the m latch circuits 224 mounted in the m mounting regions Lt. When the latch signal LAT received by each of the m latch circuits 224 mounted in the m mounting regions Lt rises, the m latch circuits 224 mounted in the m mounting regions Lt simultaneously latch the print data SId [SIH, SIM, SIL] retained in the corresponding registers 222.

The wiring Wlt, a wiring Wch, a wiring Wsg, and a wiring Wvh are electrically coupled to the m decoders 226 mounted in the m mounting regions Dec. The wiring Wch is also electrically coupled to the terminal Tch. The wiring Wsg is also electrically coupled to the terminal Tsg. The wiring Wvh is also electrically coupled to the terminal Tvh. As described above, the wiring Wlt is also electrically coupled to the terminal Tlt. Each of the m decoders 226 mounted in the m mounting regions Dec is also electrically coupled to the corresponding latch circuit 224 via a wiring pattern. Specifically, the latch circuit 224 mounted in the i-th mounting region Lt from the short side 311 side among the m mounting regions Lt is electrically coupled via a wiring pattern to the decoder 226 mounted in the i-th mounting region Dec from the short side 311 side among the m mounting regions Dec, and the latch circuit 224 mounted in an (i+1)-th mounting region Lt from the short side 311 side among the m mounting regions Lt is electrically coupled via a wiring pattern to the decoder 226 mounted in an (i+1)-th mounting region Dec from the short side 311 side among the m mounting regions Dec.

The latch signal LAT supplied to the terminal Tlt, the change signal CH supplied to the terminal Tch, and the test timing signal TSIG supplied to the terminal Tsg are propagated through the wiring Wlt, the wiring Wch, and the wiring Wsg, respectively, and are received by the m decoders 226 mounted in the m mounting regions Dec. The voltage signal VHV supplied to the terminal Tvh is propagated through the wiring Wvh and received by each of the m decoders 226 mounted in the m mounting regions Dec. In each of the periods tp1 and tp2 defined by the latch signal LAT and the change signal CH and the periods ts1, ts2, ts3 defined by the latch signal LAT and the test timing signal TSIG, each of the m decoders 226 mounted in the m mounting regions Dec outputs the selection signals Sa, Sb, Sc obtained by level-shifting a signal at a logic level corresponding to the signal latched by the corresponding latch circuit 224 to a high-amplitude logic corresponding to the voltage signal VHV.

A wiring Wca, a wiring Wcb, and the wiring Wvh are electrically coupled to the m selection circuits 230 mounted in the m mounting regions Sel. The wiring Wca is also electrically coupled to the terminal Tca. The wiring Wcb is also electrically coupled to the terminal Tcb. As described above, the wiring Wvh is also electrically coupled to the terminal Tvh. Each of the m selection circuits 230 mounted in the m mounting regions Sel is also electrically coupled to the corresponding decoder 226 via a wiring Wsa through which the selection signal Sa is propagated, a wiring Wsb through which the selection signal Sb is propagated, and a wiring Wsc through which the selection signal Sc is propagated. Specifically, the decoder 226 mounted in the i-th mounting region Dec from the short side 311 side among the m mounting regions Dec is electrically coupled via the wirings Wsa, Wsb, and Wsc to the selection circuit 230 mounted in the i-th mounting region Sel from the short side 311 side among the m mounting regions Sel, and the decoder 226 mounted in an (i+1)-th mounting region Dec from the short side 311 side among the m mounting regions Dec is electrically coupled via the wirings Wsa, Wsb, and Wsc to the selection circuit 230 mounted in an (i+1)-th mounting region Sel from the short side 311 side among the m mounting regions Sel.

The drive voltage signal ComA supplied to the terminal Tca and the drive voltage signal ComB supplied to the terminal Tcb are propagated through the corresponding wirings Wca and Wcb, respectively, and are received by the m selection circuits 230 mounted in the m mounting regions Sel. Each of the m selection circuits 230 mounted in the m mounting regions Sel selects or deselects the drive voltage signals ComA and ComB during the periods tp1, tp2 and the periods ts1, ts2, and ts3 according to the logic levels of the selection signals Sa, Sb, and Sc propagated and received through the wiring Wsa, Wsb, and Wsc, thereby generating the drive voltage signal Vin. The drive voltage signal Vin generated by each of the m selection circuits 230 mounted in the m mounting regions Sel is output from the integrated circuit 300 via the corresponding terminal Tvi. Accordingly, the piezoelectric element 60 provided at the corresponding discharge portion 600 is driven.

Each of the m selection circuits 230 mounted in the m mounting regions Sel receives the residual vibration signal Vout output from the piezoelectric element 60 corresponding to the residual vibration generated after the ink is discharged from the corresponding discharge portion 600. Each of the m selection circuits 230 mounted in the m mounting regions Sel acquires the received residual vibration signal Vout according to the logic levels of the selection signals Sa, Sb, and Sc propagated and received through the wiring Wsa, Wsb, and Wsc, and outputs the residual vibration signal Vout as the residual vibration detection signal NVT.

The voltage signal VHV supplied to the terminal Tvh is propagated through the wiring Wvh and received by each of the m mounting regions Sel. The voltage signal VHV received by each of the m mounting regions Sel is supplied to an N-well region Nwell to be described later provided in each of the m mounting regions Sel.

A specific example of the mounting region Sel where the selection circuit 230 is mounted will be described. FIG. 10 shows an example of a configuration of the mounting region Sel where the selection circuit 230 is mounted. In FIG. 10, the logic inversion circuits 232a and 232b provided at the selection circuit 230 are shown in a simplified manner. Here, in FIG. 10, description will be presented using an x1 axis and a y1 axis orthogonal to each other, which are axes independent of the X axis and the Y axis shown in FIG. 9. In the description in FIG. 10, a tip side of an arrow indicating the shown x1 axis may be referred to as a +x1 side and a starting point side may be referred to as a −x1 side, a tip side of an arrow indicating the shown y1 axis may be referred to as a +y1 side and a starting point side may be referred to as a −y1 side, and a view in which the mounting region Sel is viewed from a normal direction of a plane formed of the x1 axis and the y1 axis may be referred to as a plan view of the mounting region Sel.

As shown in FIG. 10, the mounting region Sel includes a P-type board region Psub and the N-well region Nwell. The P-type board region Psub is a region where an impurity such as boron is added to a wafer board made of silicon or the like, and the N-well region Nwell is a region where an impurity such as phosphorus is added to the P-type board region Psub. A ground signal GND at the ground potential is supplied to the P-type board region Psub, and the voltage signal VHV is supplied to the N-well region Nwell.

N-type diffusion layers 331, 332, 333, 341, 342, 343, and electrodes 334, 335, 344, and 345 are formed in the P-type board region Psub.

The N-type diffusion layers 331, 332, and 333 are aligned in an order of the N-type diffusion layer 331, the N-type diffusion layer 332, and the N-type diffusion layer 333 from the −x1 side to the +x1 side along the x1 axis. The electrodes 334 and 335 are aligned in an order of the electrode 334 and the electrode 335 from the −x1 side to the +x1 side along the x1 axis. At this time, in the plan view of the mounting region Sel, an end of the electrode 334 on the −x1 side overlaps a part of the N-type diffusion layer 331 and an end thereof on the +x1 side overlaps a part of the N-type diffusion layer 332, and in the plan view of the mounting region Sel, an end of the electrode 335 on the −x1 side overlaps a part of the N-type diffusion layer 332 and an end thereof on the +x1 side overlaps a part of the N-type diffusion layer 333. That is, in the plan view of the mounting region Sel, the electrode 334 is located between the N-type diffusion layer 331 and the N-type diffusion layer 332 to bridge the N-type diffusion layer 331 and the N-type diffusion layer 332, and in the plan view of the mounting region Sel, the electrode 335 is located between the N-type diffusion layer 332 and the N-type diffusion layer 333 to bridge the N-type diffusion layer 332 and the N-type diffusion layer 333. Between the electrode 334 and the P-type board region Psub and between the electrode 335 and the P-type board region Psub, oxide films or the like (not shown) are formed as insulating layers.

The N-type diffusion layers 341, 342, and 343 are located on the +y1 side of the N-type diffusion layers 331, 332, and 333 in an order of the N-type diffusion layer 341, the N-type diffusion layer 342, and the N-type diffusion layer 343 from the −x1 side toward the +x1 side along the x1 axis. The electrodes 344 and 345 are aligned in an order of the electrode 344 and the electrode 345 from the −x1 side to the +x1 side along the x1 axis. At this time, in the plan view of the mounting region Sel, an end of the electrode 344 on the −x1 side overlaps a part of the N-type diffusion layer 341 and an end thereof on the +x1 side overlaps a part of the N-type diffusion layer 342, and in the plan view of the mounting region Sel, an end of the electrode 345 on the −x1 side overlaps a part of the N-type diffusion layer 342 and an end thereof on the +x1 side overlaps a part of the N-type diffusion layer 343. That is, in the plan view of the mounting region Sel, the electrode 344 is located between the N-type diffusion layer 341 and the N-type diffusion layer 342 to bridge the N-type diffusion layer 341 and the N-type diffusion layer 342, and in the plan view of the mounting region Sel, the electrode 345 is located between the N-type diffusion layer 342 and the N-type diffusion layer 343 to bridge the N-type diffusion layer 342 and the N-type diffusion layer 343. Between the electrode 344 and the P-type board region Psub and between the electrode 345 and the P-type board region Psub, oxide films or the like (not shown) are formed as insulating layers.

P-type diffusion layers 351, 352, 353, and electrodes 354 and 355 are formed in the N-well region Nwell.

The P-type diffusion layers 351, 352, and 353 are located on the +y1 side of the N-type diffusion layers 341, 342, and 343, and are aligned in an order of the P-type diffusion layer 351, the P-type diffusion layer 352, and the P-type diffusion layer 353 from the −x1 side toward the +x1 side along the x1 axis. The electrodes 354 and 355 are aligned in an order of the electrode 354 and the electrode 355 from the −x1 side to the +x1 side along the x1 axis. At this time, in the plan view of the mounting region Sel, an end of the electrode 354 on the −x1 side overlaps a part of the P-type diffusion layer 351 and an end thereof on the +x1 side overlaps a part of the P-type diffusion layer 352, and in the plan view of the mounting region Sel, an end of the electrode 355 on the −x1 side overlaps a part of the P-type diffusion layer 352 and an end thereof on the +x1 side overlaps a part of the P-type diffusion layer 353. That is, in the plan view of the mounting region Sel, the electrode 354 is located between the P-type diffusion layer 351 and the P-type diffusion layer 352 to bridge the P-type diffusion layer 351 and the P-type diffusion layer 352, and in the plan view of the mounting region Sel, the electrode 355 is located between the P-type diffusion layer 352 and the P-type diffusion layer 353 to bridge the P-type diffusion layer 352 and the P-type diffusion layer 353. Between the electrode 354 and the N-well region Nwell and between the electrode 345 and the N-well region Nwell, oxide films or the like (not shown) are formed as insulating layers.

In the selection circuit 230 mounted in the mounting region Sel as described above, the drive voltage signal ComA is received by the N-type diffusion layer 341 and the P-type diffusion layer 351 via an electrode (not shown), and the drive voltage signal ComB is received by the N-type diffusion layer 343 and the P-type diffusion layer 353 via an electrode (not shown). The selection signal Sa is received by the electrode 344 and is also received by the electrode 354 after the logic level thereof is inverted in the logic inversion circuit 232a, the selection signal Sb is received by the electrode 345 and is also received by the electrode 355 after the logic level thereof is inverted in the logic inversion circuit 232b, and the selection signal Sc is received by the electrodes 334 and 335. The selection circuit 230 mounted in the mounting region Sel outputs a signal of the N-type diffusion layer 342 and the P-type diffusion layer 352 as the drive voltage signal Vin via an electrode (not shown), and outputs the residual vibration signal Vout generated at the corresponding discharge portion 600 in response to the drive voltage signal Vin from the N-type diffusion layers 331 and 333 via an electrode (not shown) and the N-type diffusion layer 332.

Specifically, when the H level selection signal Sa is received by the selection circuit 230 mounted in the mounting region Sel, in the plan view of the mounting region Sel, a channel having a channel width Wcn2 is formed in the P-type board region Psub overlapping the electrode 344 between the N-type diffusion layer 341 and the N-type diffusion layer 342, and in the plan view of the mounting region Sel, a channel having a channel width Wcn3 is formed in the N-well region Nwell overlapping the electrode 354 between the P-type diffusion layer 351 and the P-type diffusion layer 352. Accordingly, the drive voltage signal ComA supplied to the N-type diffusion layer 341 and the P-type diffusion layer 351 is supplied to the N-type diffusion layer 342 and the P-type diffusion layer 352, and is output as the drive voltage signal Vin.

Similarly, when the H level selection signal Sb is received by the selection circuit 230 mounted in the mounting region Sel, in the plan view of the mounting region Sel, a channel having the channel width Wcn2 is formed in the P-type board region Psub overlapping the electrode 345 between the N-type diffusion layer 342 and the N-type diffusion layer 343, and in the plan view of the mounting region Sel, a channel having the channel width Wcn3 is formed in the N-well region Nwell overlapping the electrode 355 between the P-type diffusion layer 352 and the P-type diffusion layer 353. Accordingly, the drive voltage signal ComB supplied to the N-type diffusion layer 343 and the P-type diffusion layer 353 is supplied to the N-type diffusion layer 342 and the P-type diffusion layer 352, and is output as the drive voltage signal Vin.

When the H level selection signal Sc is received by the selection circuit 230 mounted in the mounting region Sel, in the plan view of the mounting region Sel, a channel having a channel width Wcn1 is formed in the P-type board region Psub overlapping the electrode 334 between the N-type diffusion layer 331 and the N-type diffusion layer 332, and in the plan view of the mounting region Sel, a channel having the channel width Wcn1 is formed in the P-type board region Psub overlapping the electrode 335 between the N-type diffusion layer 332 and the N-type diffusion layer 333. Accordingly, a signal supplied to the N-type diffusion layer 332, that is, the residual vibration signal Vout corresponding to the residual vibration generated at the corresponding discharge portion 600 in response to the drive voltage signal Vin is supplied to the N-type diffusion layers 331 and 333 and output as the residual vibration signal Vout.

That is, the N-type diffusion layers 341, 342, and the electrode 344 constitute the n-type transistor 236a provided at the switch circuit 234a, the P-type diffusion layers 351, 352, and the electrode 354 constitute the p-type transistor 238a provided at the switch circuit 234a, the N-type diffusion layers 343, 342, and the electrode 345 constitute the n-type transistor 236b provided at the switch circuit 234b, the P-type diffusion layers 353, 352, and the electrode 355 constitute the p-type transistor 238b provided at the switch circuit 234b, and the N-type diffusion layers 331, 332, the electrode 334, the N-type diffusion layers 332, 333, and the electrode 335 constitute the n-type transistor 236c provided at the switch circuit 234c.

At this time, the ground signal GND at the ground potential supplied to the P-type board region Psub is supplied to a back gate terminal of the n-type transistor 236a provided at the switch circuit 234a, a back gate terminal of the n-type transistor 236b provided at the switch circuit 234b, and a back gate terminal of the n-type transistor 236c provided at the switch circuit 234c, and the voltage signal VHV supplied to the N-well region Nwell is supplied to a back gate terminal of the p-type transistor 238a provided at the switch circuit 234a and a back gate terminal of the p-type transistor 238b provided at the switch circuit 234b.

Referring back to FIG. 9, m wirings Wsc electrically coupled to the m decoders 226 mounted in the m mounting regions Dec are electrically coupled to the OR circuit 244 mounted in the mounting region Or. As described above, the selection signal Sc output from the corresponding decoder 226 is propagated to each wiring Wsc. Accordingly, m selection signals Sc output from the m decoders 226 mounted in the m mounting regions Dec are received by the OR circuit 244 mounted in the mounting region Or. The OR circuit 244 mounted in the mounting region Or outputs the switch control signal SS at the H level when at least one of the m received selection signals Sc is at the H level, and outputs the switch control signal SS at the L level when all of the m received selection signals Sc are at the L level.

A wiring Wss and the wiring Wcb are electrically coupled to the switch circuit 242 mounted in the mounting region Sw. The wiring Wss is also electrically coupled to the OR circuit 244 mounted in the mounting region Or to propagate the switch control signal SS output from the OR circuit 244 mounted in the mounting region Or. As described above, the wiring Wcb is also electrically coupled to the terminal Tcb to propagate the drive voltage signal ComB supplied to the terminal Tcb. Accordingly, the switch circuit 242 mounted in the mounting region Sw receives the switch control signal SS output from the OR circuit 244 mounted in the mounting region Or and the drive voltage signal ComB. When the switch control signal SS output from the OR circuit 244 mounted in the mounting region Or is at the H level, the switch circuit 242 mounted in the mounting region Sw outputs the drive voltage signal ComB propagated and supplied through the wiring Wcb as the drive voltage signal bCom, and when the switch control signal SS output from the OR circuit 244 mounted in the mounting region Or is at the L level, the switch circuit 242 stops outputting the drive voltage signal ComB as the drive voltage signal bCom.

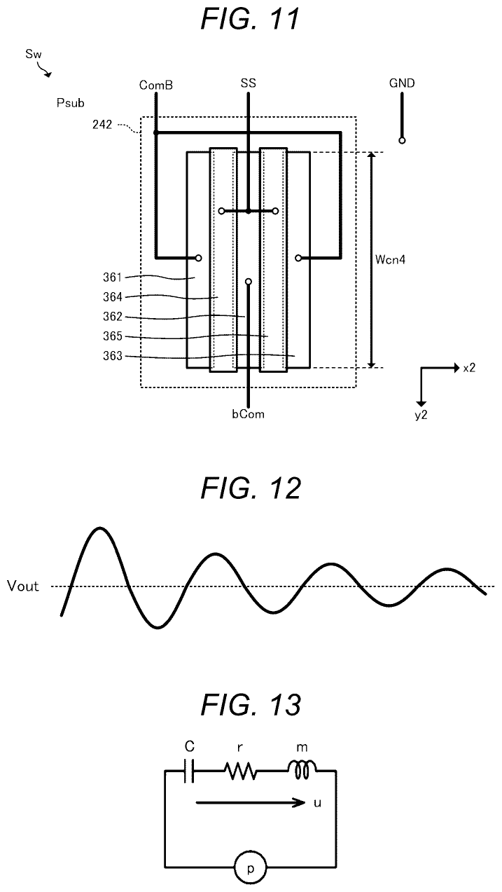

Here, a specific example of the mounting region Sw where the switch circuit 242 including the n-type transistor 242a is mounted will be described. FIG. 11 shows an example of a configuration of the mounting region Sw where the switch circuit 242 is mounted. Here, in FIG. 11, description will be presented using an x2 axis and a y2 axis orthogonal to each other, which are axes independent of the X axis and the Y axis shown in FIG. 9 and the x1 axis and the y1 axis shown in FIG. 10. In the description in FIG. 11, a tip side of an arrow indicating the shown x2 axis may be referred to as a +x2 side and a starting point side may be referred to as a −x2 side, a tip side of an arrow indicating the shown y2 axis may be referred to as a +y2 side and a starting point side may be referred to as a −y2 side, and a view in which the mounting region Sw is viewed from a normal direction of a plane formed of the x2 axis and the y2 axis may be referred to as a plan view of the mounting region Sw.

As shown in FIG. 11, the mounting region Sw includes the P-type board region Psub. The P-type board region Psub is a region where an impurity such as boron is added to a wafer board made of silicon or the like, and the ground signal GND at the ground potential is supplied to the P-type board region Psub.

N-type diffusion layers 361, 362, 363, and electrodes 364 and 365 are formed in the P-type board region Psub in the mounting region Sw.

The N-type diffusion layers 361, 362, and 363 are aligned in an order of the N-type diffusion layer 361, the N-type diffusion layer 362, and the N-type diffusion layer 363 from the −x2 side to the +x2 side along the x2 axis. The electrodes 364 and 365 are aligned in an order of the electrode 364 and the electrode 365 from the −x2 side to the +x2 side along the x2 axis. At this time, in the plan view of the mounting region Sw, an end of the electrode 364 on the −x2 side overlaps a part of the N-type diffusion layer 361 and an end thereof on the +x2 side overlaps a part of the N-type diffusion layer 362, and in the plan view of the mounting region Sw, an end of the electrode 365 on the −x2 side overlaps a part of the N-type diffusion layer 362 and an end thereof on the +x2 side overlaps a part of the N-type diffusion layer 363. That is, in the plan view of the mounting region Sw, the electrode 364 is located between the N-type diffusion layer 361 and the N-type diffusion layer 362 to bridge the N-type diffusion layer 361 and the N-type diffusion layer 362, and in the plan view of the mounting region Sw, the electrode 365 is located between the N-type diffusion layer 362 and the N-type diffusion layer 363 to bridge the N-type diffusion layer 362 and the N-type diffusion layer 363. Between the electrode 364 and the P-type board region Psub and between the electrode 365 and the P-type board region Psub, oxide films or the like (not shown) are formed as insulating layers.

In the switch circuit 242 mounted in the mounting region Sw as described above, the drive voltage signal ComB is received by the N-type diffusion layers 361 and 363 via an electrode (not shown). The switch control signal SS is received by the electrodes 364 and 365. The n-type transistor 242a mounted in the mounting region Sw outputs a signal of the n-type diffusion layer 362 as the drive voltage signal bCom via an electrode (not shown).

Specifically, when the H level switch control signal SS is received by the switch circuit 242 mounted in the mounting region Sw, in the plan view of the mounting region Sw, a channel having a channel width Wcn4 is formed in the P-type board region Psub overlapping the electrode 364 between the N-type diffusion layer 361 and the N-type diffusion layer 362, and in the plan view of the mounting region Sw, a channel having the channel width Wcn4 is formed in the P-type board region Psub overlapping the electrode 365 between the N-type diffusion layer 362 and the N-type diffusion layer 363. Accordingly, the drive voltage signal ComB supplied to the N-type diffusion layers 361 and 363 is supplied to the N-type diffusion layer 362 and output as the drive voltage signal bCom. That is, the N-type diffusion layers 361, 362, the electrode 364, the N-type diffusion layers 362, 363, and the electrode 365 constitute the n-type transistor 242a. At this time, the ground signal GND at the ground potential supplied to the P-type board region Psub is supplied to a back gate terminal of the n-type transistor 242a.

Referring back to FIG. 9, a wiring Wbc, a wiring Wvo, and the wiring Wvh are electrically coupled to the residual vibration detection circuit 250 mounted in the mounting region Amp. The wiring Wbc is also electrically coupled to the n-type transistor 242a mounted in the mounting region Sw, the wiring Wvo is electrically coupled to each of the m selection circuits 230 mounted in the m mounting regions Sel, and the wiring Wvh is also electrically coupled to the terminal Tvh. The wiring Wbc propagates the drive voltage signal bCom output from the n-type transistor 242a mounted in the mounting region Sw, the wiring Wvo propagates the residual vibration signal dVout that is the residual vibration signal Vout output from each of the m selection circuits 230 mounted in the m mounting regions Sel, and the wiring Wvh propagates the voltage signal VHV. Accordingly, the drive voltage signal bCom and the residual vibration signal dVout are received by the residual vibration detection circuit 250 mounted in the mounting region Amp. In the mounting region Amp, the voltage signal VHV is used as a reference potential for a well region where several circuit elements constituting the residual vibration detection circuit 250 are mounted.

The residual vibration detection circuit 250 mounted in the mounting region Amp amplifies the signal corresponding to the difference between the drive voltage signal bCom and the residual vibration signal dVout thus received, and thus generates and outputs the residual vibration detection signal NVT. That is, the residual vibration detection circuit 250 outputs the residual vibration detection signal NVT obtained by differentially amplifying the residual vibration signal Vout received via the n-type transistor 236c and the drive voltage signal ComB received via the n-type transistor 242a.

The residual vibration detection signal NVT output from the residual vibration detection circuit 250 mounted in the mounting region Amp is propagated through a wiring Wnv electrically coupled to the residual vibration detection circuit 250 mounted in the mounting region Amp and is output from the terminal Tnv.

### 1.4 Residual Vibration Signal and Determination of State of Discharge Portion

Here, a specific example of the residual vibration generated at the discharge portion 600 after the drive voltage signal Vin is supplied to the discharge portion 600 and a specific example of the residual vibration signal Vout corresponding to the residual vibration will be described. After the piezoelectric element 60 provided at the discharge portion 600 is driven according to the drive voltage signal Vin including the drive waveform Bdp1, the liquid discharge apparatus 1 in the embodiment acquires the residual vibration signal Vout corresponding to the residual vibration generated at the discharge portion 600 and determines the state of the corresponding discharge portion 600 based on the residual vibration detection signal NVT corresponding to the acquired residual vibration signal Vout.

Specifically, in the liquid discharge apparatus 1 in the embodiment, the piezoelectric element 60 provided at the corresponding discharge portion 600 is driven by being supplied with the drive voltage signal Vin including the drive waveform Bdp1. Then, the vibration plate 621 is displaced by driving the piezoelectric element 60, and the internal pressure of the pressure chamber 631 changes due to the displacement of the vibration plate 621. Thereafter, the voltage value of the drive voltage signal Vin supplied to the piezoelectric element 60 is constant, and thus a damped vibration occurs at the vibration plate 621 in response to the change in the internal pressure of the pressure chamber 631. At this time, the piezoelectric element 60 is displaced due to the damped vibration generated at the vibration plate 621. Then, electric charge corresponding to the displacement is discharged from the piezoelectric element 60. A signal corresponding to the electric charge discharged from the piezoelectric element 60 due to the damped vibration generated at the vibration plate 621 corresponds to the residual vibration signal Vout.

FIG. 12 shows an example of the residual vibration signal Vout. As shown in FIG. 12, the signal waveform of the residual vibration signal Vout is a damped vibration waveform in which voltage amplitude decreases over time according to the damped vibration generated at the vibration plate 621 as the internal pressure of the pressure chamber 631 changes. Waveform information such as amplitude and a cycle in the damped vibration waveform of the residual vibration signal Vout changes depending on a state of the ink stored in the pressure chamber 631.

Here, a relationship between the waveform information on the residual vibration signal Vout and the state of the ink stored in the pressure chamber 631 will be described using a calculation model. FIG. 13 shows an example of a calculation model of a simple harmonic motion assuming a residual vibration generated at the pressure chamber 631 or the vibration plate 621. As described above, the piezoelectric element 60 is displaced by being supplied with the drive voltage signal Vin, and the vibration plate 621 is also displaced due to the displacement of the piezoelectric element 60. Then, the volume of the pressure chamber 631 corresponding to the displacement of the vibration plate 621 changes. At this time, a part of the ink filled in the pressure chamber 631 is discharged from the nozzle 651 according to pressure generated inside the pressure chamber 631.

In such a series of operations for discharging the ink from the nozzle 651, the vibration plate 621 freely vibrates at natural vibration frequency determined depending on flow path resistance r based on a shape of a flow path through which the ink flows and viscosity of the ink, inertance m due to a liquid weight in the flow path, and compliance C of the vibration plate 621, and the piezoelectric element 60 displaces corresponding to the free vibration generated at the vibration plate 621. A signal of electric charge generated by the displacement of the piezoelectric element 60 is output as the residual vibration signal Vout.

Such a calculation model of the residual vibration generated at the vibration plate 621 can be expressed by pressure p, the inertance m, the compliance C, and the flow path resistance r. Then, by calculating a step response when the pressure p is applied to a circuit shown in FIG. 13 relative to volume velocity u, the following Formulas (1) to (3) are obtained.

$$\begin{matrix}Math . 1 & \\ u = \frac{p}{ω \cdot m} {e}^{- α \cdot t} \cdot sin ω t & ( 1 )\end{matrix}$$

$$\begin{matrix}Math . 2 & \\ ω = \sqrt{\frac{1}{m \cdot {C}_{m}} - {α}^{2}} & ( 2 )\end{matrix}$$

$$\begin{matrix}Math . 3 & \\ α = \frac{r}{2 m} & ( 3 )\end{matrix}$$

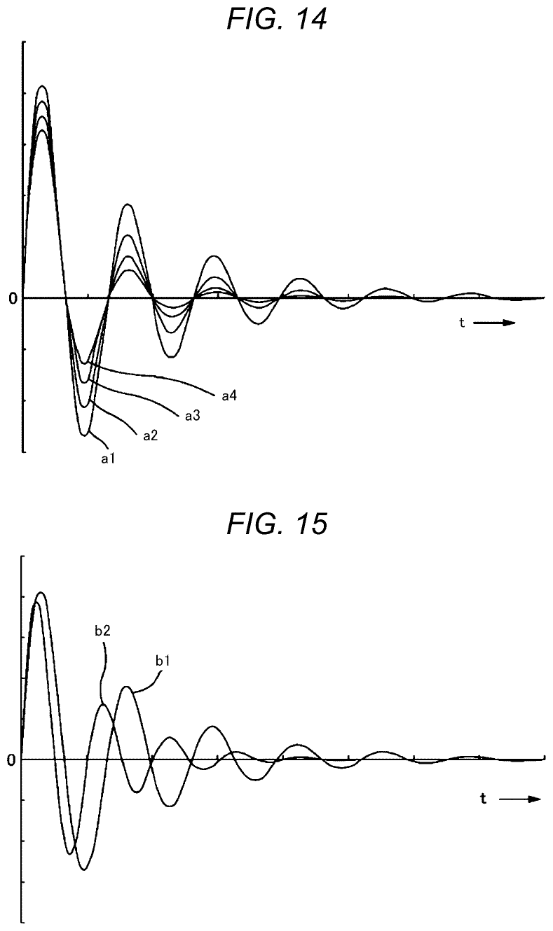

FIG. 14 shows a relationship between the viscosity of the ink and the signal waveform of the residual vibration signal Vout. In FIG. 14, a horizontal axis represents time, and a vertical axis represents magnitude of the residual vibration. FIG. 14 shows a signal waveform when the viscosity of the ink, that is, a viscosity increase factor is 1.0 as a waveform a1, a signal waveform when the viscosity increase factor is 1.4 as a waveform a2, a signal waveform when the viscosity increase factor is 1.8 as a waveform a3, and a signal waveform when the viscosity increase factor is 2.2 as a waveform a4.

As shown in FIG. 14, when the viscosity of the stored ink increases and the viscosity increase factor increases, amplitude of the residual vibration signal Vout and a damping ratio change. Specifically, when the viscosity of the ink or the like stored in the pressure chamber 631 increases, the flow path resistance r increases. Therefore, amplitude of the damped vibration generated at the vibration plate 621 decreases, and the damping ratio increases. As a result, when an abnormal viscosity increase occurs in the stored ink, the amplitude of the corresponding residual vibration signal Vout decreases and the damping ratio increases.

FIG. 15 shows the signal waveform of the residual vibration signal Vout when an air bubble is mixed into the pressure chamber 631. In FIG. 15, a horizontal axis represents time, and a vertical 1 axis represents magnitude of the residual vibration. In FIG. 15, a signal waveform in a normal state in which no air bubble is mixed in the pressure chamber 631 is shown as a waveform b1, and an example of a signal waveform when the air bubble is mixed in the pressure chamber 631 is shown as a waveform b2.

As shown in FIG. 15, when the air bubble is mixed in the pressure chamber 631, vibration frequency of the residual vibration signal Vout increases. Specifically, when the air bubble is mixed into the inside of the pressure chamber 631, the inertance m corresponding to a weight of the stored ink is decreased by an amount of the mixed air bubble. When the inertance m decreases, angular velocity ω increases as shown in Formula (2). Accordingly, a vibration cycle of the residual vibration generated at the vibration plate 621 is shortened, and as a result, the vibration frequency of the residual vibration signal Vout increases, and the cycle is shortened.

As described above, when a viscosity increase anomaly in which the viscosity of the ink increases or an air bubble mixing anomaly in which the air bubble is mixed occurs in the pressure chamber 631, the waveform information such as the amplitude and the cycle of the residual vibration signal Vout changes. Therefore, the state of the discharge portion 600 including the piezoelectric element 60 that outputs the residual vibration signal Vout can be determined based on the waveform information such as the amplitude and the cycle of the residual vibration signal Vout.

In the liquid discharge apparatus 1 in the embodiment, the drive signal selection circuit 200 acquires and shapes the residual vibration signal Vout to output the residual vibration signal Vout as the residual vibration detection signal NVT. Then, the waveform information such as the amplitude and the cycle in the residual vibration detection signal NVT corresponding to the residual vibration signal Vout is extracted in the waveform information output circuit 270, and the control circuit 100 determines the state of the corresponding discharge portion 600 based on the waveform information extracted in the waveform information output circuit 270.

Here, the drive voltage signal ComB is an example of a drive signal, the switch circuit 234c and the n-type transistor 236c that is the N-channel type transistor are examples of a first switch circuit, the switch circuit 242 and the n-type transistor 242a that is the N-channel type transistor are examples of a second switch circuit, and the control circuit 100 is an example of a processor.

### 1.5 Functions and Effects

The liquid discharge apparatus 1 and the print head 21 in the embodiment implemented as described above include the pressure chamber 631 whose volume changes according to the drive voltage signal ComB, the nozzle 651 that communicates with the pressure chamber 631 and discharges the liquid, the piezoelectric element 60 that outputs the residual vibration signal Vout corresponding to the residual vibration caused by a change in the volume of the pressure chamber 631, the residual vibration detection circuit 250 that receives the residual vibration signal Vout and outputs the residual vibration detection signal NVT corresponding to the residual vibration signal Vout, and the switch circuit 234c that switches whether to supply the residual vibration signal Vout to the residual vibration detection circuit 250. The switch circuit 234c includes only the n-type transistor 236c that is the N-channel type transistor and includes no P-channel type transistor.

When the switch circuit 234c includes the P-channel type transistor, a signal having a higher potential than a maximum voltage value of the drive voltage signal ComB, for example, the voltage signal VHV is supplied to a back gate terminal of the P-channel type transistor. A high potential signal such as the voltage signal VHV is generated by a high efficiency switching power supply circuit such as a switching regulator from the viewpoint of increasing conversion efficiency associated with the generation of the signal. However, a ripple voltage due to a circuit characteristic is superimposed on the signal generated by the switching power supply circuit.

When the P-channel type transistor is provided at the switch circuit 234c for switching whether to supply the residual vibration signal Vout to the residual vibration detection circuit 250, the ripple voltage superimposed on the voltage signal VHV may contribute to the residual vibration signal Vout via the back gate terminal. In particular, since a signal associated with the electric charge output from the piezoelectric element 60 corresponding to the residual vibration generated at the discharge portion 600 is fairly weak, an influence of the ripple voltage superimposed on the voltage signal VHV is large. That is, when the ripple voltage superimposed on the voltage signal VHV contributes to the residual vibration signal Vout, detection accuracy of the residual vibration signal Vout, that is, detection accuracy of the signal associated with the electric charge output from the piezoelectric element 60 corresponding to the residual vibration generated at the discharge portion 600 may decrease.

In contrast, in the liquid discharge apparatus 1 and the print head 21 in the embodiment, the switch circuit 234c that switches whether to supply the residual vibration signal Vout to the residual vibration detection circuit 250 includes only the n-type transistor 236c that is the N-channel type transistor, and thus a risk that the ripple voltage superimposed on the high-voltage voltage signal VHV is superimposed on the residual vibration signal Vout is reduced. As a result, the detection accuracy of the residual vibration signal Vout, that is, detection accuracy of the residual vibration generated after the piezoelectric element 60 is driven can be improved.

In the liquid discharge apparatus 1 and the print head 21 in the embodiment, in addition to the n-type transistor 236c that is the switch circuit 234c for switching whether to supply the residual vibration signal Vout to the residual vibration detection circuit 250, the switch circuit 242 that switches whether to supply the drive voltage signal ComB to the residual vibration detection circuit 250 includes the n-type transistor 242a that is the N-channel type transistor, the back gate terminal of the n-type transistor 236c is supplied with a signal at a constant potential, that is, the ground signal GND at the ground potential, and the ground signal GND is also supplied to the back gate terminal of the n-type transistor 242a. That is, a common signal is supplied to the back gate terminal of the n-type transistor 236c and the back gate terminal of the n-type transistor 242a. The residual vibration detection circuit 250 outputs the residual vibration detection signal NVT obtained by differentially amplifying the residual vibration signal Vout received via the n-type transistor 236c and the drive voltage signal ComB received via the n-type transistor 242a.

In the print head 21 implemented as described above, when a signal is superimposed on the residual vibration signal Vout via the back gate terminal of the n-type transistor 236c, the same signal is also superimposed on the drive voltage signal ComB via the back gate terminal of the n-type transistor 242a. Then, the residual vibration detection circuit 250 differentially amplifies the residual vibration signal Vout received via the n-type transistor 236c and the drive voltage signal ComB received via the n-type transistor 242a, thus the signal superimposed on the residual vibration signal Vout via the back gate terminal of the n-type transistor 236c is canceled out by the signal superimposed on the drive voltage signal ComB via the back gate terminal of the n-type transistor 242a. Accordingly, even when a signal is superimposed on the residual vibration signal Vout via the back gate terminal of the n-type transistor 236c, a risk that a signal in which the signal is superimposed on the residual vibration signal Vout contributes to the residual vibration detection signal NVT output from the residual vibration detection circuit 250 is reduced. As a result, the detection accuracy of the residual vibration generated after the piezoelectric element 60 is driven can be improved.

### 2. Second Embodiment

Next, the liquid discharge apparatus 1 according to a second embodiment will be described. In the description of the liquid discharge apparatus 1 according to the second embodiment, substantially the same configurations as those in the liquid discharge apparatus 1 in the first embodiment are denoted by the same reference numerals, and description thereof will be omitted or simplified.

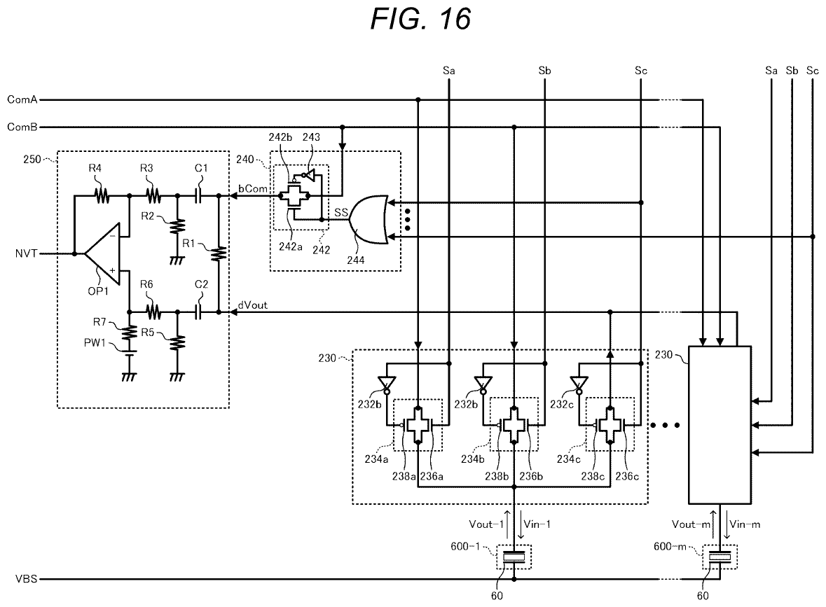

FIG. 16 shows an example of circuit configurations of the selection circuit 230, the switching circuit 240, and the residual vibration detection circuit 250 of the drive signal selection circuit 200 in the second embodiment. As shown in FIG. 16, the liquid discharge apparatus 1 in the second embodiment is different from the liquid discharge apparatus 1 in the first embodiment in that the selection circuit 230 includes a logic inversion circuit 232c, the switch circuit 234c of the selection circuit 230 includes a p-type transistor 238c, and the switch circuit 242 of the switching circuit 240 includes a p-type transistor 242b and a logic inversion circuit 243 in the drive signal selection circuit 200.

Specifically, in the liquid discharge apparatus 1 in the second embodiment, the switch circuit 234c includes the p-type transistor 238c in addition to the n-type transistor 236c. The one end of the n-type transistor 236c is electrically coupled to one end of the p-type transistor 238c, and the other end of the n-type transistor 236c is electrically coupled to the other end of the p-type transistor 238c. A coupling point where the one end of the n-type transistor 236c and the one end of the p-type transistor 238c are electrically coupled is electrically coupled to the one end of the residual vibration detection circuit 250, and a coupling point where the other end of the n-type transistor 236c and the other end of the p-type transistor 238c are electrically coupled is electrically coupled to the one end of the piezoelectric element 60 provided at the discharge portion 600-1. The selection signal Sc is supplied to the gate terminal that is the control terminal of the n-type transistor 236c, and a signal obtained by inverting the logic level of the selection signal Sc with the logic inversion circuit 232c is supplied to a gate terminal that is a control terminal of the p-type transistor 238c. That is, the switch circuit 234c in the second embodiment constitutes a transmission gate. Here, the coupling point where the one end of the n-type transistor 236c and the one end of the p-type transistor 238c are electrically coupled corresponds to the one end of the switch circuit 234c, and the coupling point where the other end of the n-type transistor 236c and the other end of the p-type transistor 238c are electrically coupled corresponds to the other end of the switch circuit 234c.

When the switch circuit 234c implemented as described above receives the selection signal Sc at the H level, the one end and the other end are controlled to be conductive. As a result, the switch circuit 234c outputs, to the residual vibration detection circuit 250, the residual vibration signal Vout-1 output from the piezoelectric element 60 provided at the discharge portion 600-1. On the other hand, when the switch circuit 234c receives the selection signal Sc at the L level, the one end and the other end are controlled to be non-conductive. As a result, the switch circuit 234c does not output, to the residual vibration detection circuit 250, the residual vibration signal Vout-1 output from the piezoelectric element 60 provided at the discharge portion 600-1. That is, similarly to the switch circuit 234c in the first embodiment, the switch circuit 234c in the second embodiment switches whether to output the residual vibration signal Vout to the residual vibration detection circuit 250.

In the liquid discharge apparatus 1 in the second embodiment, the switch circuit 242 includes the p-type transistor 242b in addition to the n-type transistor 242a. The one end of the n-type transistor 242a is electrically coupled to one end of the p-type transistor 242b, and the other end of the n-type transistor 242a is electrically coupled to the other end of the p-type transistor 242b. A coupling point where the one end of the n-type transistor 242a and the one end of the p-type transistor 242b are electrically coupled is electrically coupled to a wiring pattern through which the drive voltage signal ComB is propagated, and a coupling point where the other end of the n-type transistor 242a and the other end of the p-type transistor 242b are electrically coupled is electrically coupled to the residual vibration detection circuit 250. The switch control signal SS is supplied to the gate terminal that is the control terminal of the n-type transistor 242a, and a signal obtained by inverting a logic level of the switch control signal SS with the logic inversion circuit 243 is supplied to a gate terminal that is a control terminal of the p-type transistor 242b. That is, the switch circuit 242 in the second embodiment includes a transmission gate. Here, the coupling point where the one end of the n-type transistor 242a and the one end of the p-type transistor are electrically coupled is referred to as one end of the switch circuit 242, and the coupling point where the other end of the n-type transistor 242a and the other end of the p-type transistor 242b are electrically coupled is referred to as the other end of the switch circuit 242.

When the switch circuit 242 implemented as described above receives the switch control signal SS at the H level, the one end and the other end are controlled to be conductive. As a result, the switch circuit 242 treats the drive voltage signal ComB as the drive voltage signal bCom and outputs the drive voltage signal bCom to the residual vibration detection circuit 250.

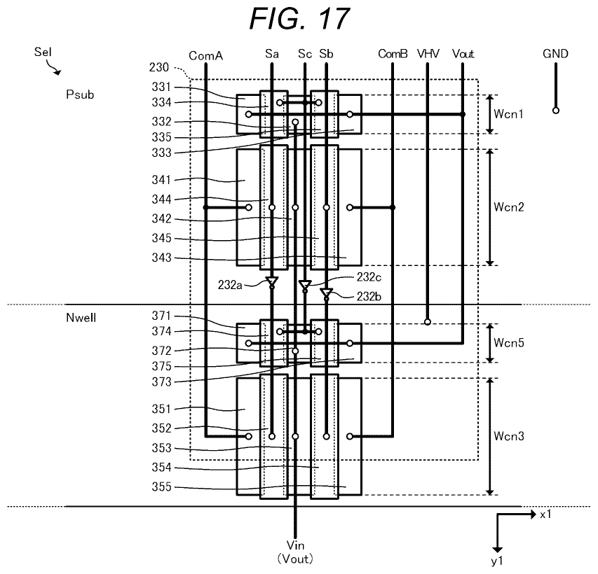

Next, a specific example of the mounting region Sel where the selection circuit 230 in the second embodiment is mounted will be described. FIG. 17 shows an example of a configuration of the mounting region Sel where the selection circuit 230 in the second embodiment is mounted. In FIG. 17, the logic inversion circuits 232a, 232b, and 232c provided at the selection circuit 230 are shown in a simplified manner. In FIG. 17, description will be presented using the x1 axis and the y1 axis orthogonal to each other, which are the same axes as in FIG. 10. In the description in FIG. 17, as in the description in FIG. 10, the tip side of the arrow indicating the shown x1 axis may be referred to as the +x1 side and the starting point side may be referred to as the −x1 side, the tip side of the arrow indicating the shown y1 axis may be referred to as the +y1 side and the starting point side may be referred to as the −y1 side, and the view in which the mounting region Sel is viewed from the normal direction of the plane formed of the x1 axis and the y1 axis may be referred to as the plan view of the mounting region Sel.

As shown in FIG. 17, similarly to the mounting region Sel in the first embodiment, the mounting region Sel in the second embodiment includes the p-type board region Psub where an impurity such as boron is added to a wafer board made of silicon or the like, and the N-well region Nwell where an impurity such as phosphorus is added to the p-type board region Psub. The ground signal GND at the ground potential is supplied to the P-type board region Psub, and the voltage signal VHV is supplied to the N-well region Nwell.

As in the first embodiment, the N-type diffusion layers 331, 332, 333, 341, 342, 343, and the electrodes 334, 335, 344, and 345 are formed in the P-type board region Psub. As in the first embodiment, the P-type diffusion layers 351, 352, 353, and the electrodes 354 and 355 are formed in the N-well region Nwell, as well as P-type diffusion layers 371, 372, 373, and electrodes 374 and 375.

The P-type diffusion layers 371, 372, and 373 are located on the +y1 side of the N-type diffusion layers 341, 342, and 343 and on the −y1 side of the P-type diffusion layers 351, 352, and 353, and are aligned in an order of the P-type diffusion layer 371, the P-type diffusion layer 372, and the P-type diffusion layer 373 from the −x1 side toward the +x1 side along the x1 axis. The electrodes 374 and 375 are aligned in an order of the electrode 374 and the electrode 375 from the −x1 side to the +x1 side along the x1 axis. At this time, in the plan view of the mounting region Sel, an end of the electrode 374 on the −x1 side overlaps a part of the P-type diffusion layer 371 and an end thereof on the +x1 side overlaps a part of the P-type diffusion layer 372, and in the plan view of the mounting region Sel, an end of the electrode 375 on the −x1 side overlaps a part of the P-type diffusion layer 372 and an end thereof on the +x1 side overlaps a part of the P-type diffusion layer 373. That is, in the plan view of the mounting region Sel, the electrode 374 is located between the P-type diffusion layer 371 and the P-type diffusion layer 372 to bridge the P-type diffusion layer 371 and the P-type diffusion layer 372, and in the plan view of the mounting region Sel, the electrode 375 is located between the P-type diffusion layer 372 and the P-type diffusion layer 373 to bridge the P-type diffusion layer 372 and the P-type diffusion layer 373. Between the electrode 374 and the N-well region Nwell and between the electrode 375 and the N-well region Nwell, oxide films or the like (not shown) are formed as insulating layers.

In the selection circuit 230 mounted in the mounting region Sel as described above, the drive voltage signal ComA is received by the N-type diffusion layer 341 and the P-type diffusion layer 351 via an electrode (not shown), and the drive voltage signal ComB is received by the N-type diffusion layer 343 and the P-type diffusion layer 353 via an electrode (not shown). The selection signal Sa is received by the electrode 344 and is also received by the electrode 354 after the logic level thereof is inverted in the logic inversion circuit 232a, the selection signal Sb is received by the electrode 345 and is also received by the electrode 355 after the logic level thereof is inverted in the logic inversion circuit 232b, and the selection signal Sc is received by the electrodes 334 and 335 and is also received by the electrodes 374 and 375 after the logic level thereof is inverted in the logic inversion circuit 232c. The selection circuit 230 mounted in the mounting region Sel outputs the signal of the N-type diffusion layer 342 and the P-type diffusion layer 352 as the drive voltage signal Vin via an electrode (not shown), outputs the residual vibration signal Vout generated at the corresponding discharge portion 600 in response to the drive voltage signal Vin from the N-type diffusion layers 331 and 333 via an electrode (not shown) and the N-type diffusion layer 332 and also from the P-type diffusion layers 371 and 373 via an electrode (not shown) and the P-type diffusion layer 372.

Specifically, when the H level selection signal Sa is received by the selection circuit 230 mounted in the mounting region Sel, in the plan view of the mounting region Sel, a channel having the channel width Wcn2 is formed in the P-type board region Psub overlapping the electrode 344 between the N-type diffusion layer 341 and the N-type diffusion layer 342, and in the plan view of the mounting region Sel, a channel having the channel width Wcn3 is formed in the N-well region Nwell overlapping the electrode 354 between the P-type diffusion layer 351 and the P-type diffusion layer 352. Accordingly, the drive voltage signal ComA supplied to the N-type diffusion layer 341 and the P-type diffusion layer 351 is supplied to the N-type diffusion layer 342 and the P-type diffusion layer 352, and is output as the drive voltage signal Vin.

Similarly, when the H level selection signal Sb is received by the selection circuit 230 mounted in the mounting region Sel, in the plan view of the mounting region Sel, a channel having the channel width Wcn2 is formed in the P-type board region Psub overlapping the electrode 345 between the N-type diffusion layer 342 and the N-type diffusion layer 343, and in the plan view of the mounting region Sel, a channel having the channel width Wcn3 is formed in the N-well region Nwell overlapping the electrode 355 between the P-type diffusion layer 352 and the P-type diffusion layer 353. Accordingly, the drive voltage signal ComB supplied to the N-type diffusion layer 343 and the P-type diffusion layer 353 is supplied to the N-type diffusion layer 342 and the P-type diffusion layer 352, and is output as the drive voltage signal Vin.

When the H level selection signal Sc is received by the selection circuit 230 mounted in the mounting region Sel, in the plan view of the mounting region Sel, a channel having the channel width Wcn1 is formed in the P-type board region Psub overlapping the electrode 334 between the N-type diffusion layer 331 and the N-type diffusion layer 332, in the plan view of the mounting region Sel, a channel having the channel width Wcn1 is formed in the P-type board region Psub overlapping the electrode 335 between the N-type diffusion layer 332 and the N-type diffusion layer 333, in the plan view of the mounting region Sel, a channel having a channel width Wcn5 is formed in the N-well region Nwell overlapping the electrode 374 between the P-type diffusion layer 371 and the P-type diffusion layer 372, and in the plan view of the mounting region Sel, a channel having the channel width Wcn5 is formed in the N-well region Nwell overlapping the electrode 375 between the P-type diffusion layer 372 and the P-type diffusion layer 373. Accordingly, a signal supplied to the N-type diffusion layer 332 and the P-type diffusion layer 372, that is, the residual vibration signal Vout corresponding to the residual vibration generated at the corresponding discharge portion 600 in response to the drive voltage signal Vin is supplied to the N-type diffusion layers 331, 333, and the P-type diffusion layers 371 and 373, and is output as the residual vibration signal Vout.

The residual vibration signal Vout that is the residual vibration signal dVout output from the N-type diffusion layers 331, 333, and the P-type diffusion layers 371 and 373 mounted in the mounting region Sel is propagated through the wiring Wvo and is received by the residual vibration detection circuit 250 mounted in the mounting region Amp.

That is, the N-type diffusion layers 341, 342, and the electrode 344 constitute the n-type transistor 236a provided at the switch circuit 234a, the P-type diffusion layers 351, 352, and the electrode 354 constitute the p-type transistor 238a provided at the switch circuit 234a, the N-type diffusion layers 343, 342, and the electrode 345 constitute the n-type transistor 236b provided at the switch circuit 234b, the P-type diffusion layers 353, 352, and the electrode 355 constitute the p-type transistor 238b provided at the switch circuit 234b, the N-type diffusion layers 331, 332, the electrode 334, the N-type diffusion layers 332, 333, and the electrode 335 constitute the n-type transistor 236c provided at the switch circuit 234c, and the P-type diffusion layers 371, 372, the electrode 374, the P-type diffusion layers 372, 373, and the electrode 375 constitute the p-type transistor 238c provided at the switch circuit 234c.

At this time, the ground signal GND at the ground potential supplied to the P-type board region Psub is supplied to the back gate terminal of the n-type transistor 236a provided at the switch circuit 234a, the back gate terminal of the n-type transistor 236b provided at the switch circuit 234b, and the back gate terminal of the n-type transistor 236c provided at the switch circuit 234c, and the voltage signal VHV supplied to the N-well region Nwell is supplied to the back gate terminal of the p-type transistor 238a provided at the switch circuit 234a, the back gate terminal of the p-type transistor 238b provided at the switch circuit 234b, and a back gate terminal of the p-type transistor 238c provided at the switch circuit 234c.

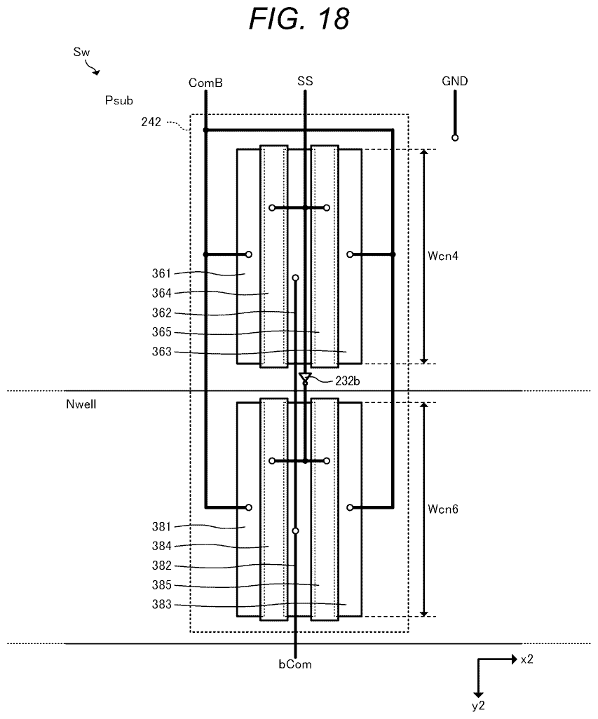

Next, a specific example of the mounting region Sw where the switch circuit 242 in the second embodiment is mounted will be described. FIG. 18 shows an example of a configuration of the mounting region Sw where the switch circuit 242 in the second embodiment is mounted. In FIG. 18, the logic inversion circuit 243 provided at the switch circuit 242 is shown in a simplified manner. Here, in FIG. 18, description will be presented using the x2 axis and the y2 axis orthogonal to each other, which are the same axes as in FIG. 11. In the description in FIG. 18, the tip side of the arrow indicating the shown x2 axis may be referred to as the +x2 side and the starting point side may be referred to as the −x2 side, the tip side of the arrow indicating the shown y2 axis may be referred to as the +y2 side and the starting point side may be referred to as the −y2 side, and the view in which the mounting region Sw is viewed from the normal direction of the plane formed of the x2 axis and the y2 axis may be referred to as the plan view of the mounting region Sw.

As shown in FIG. 18, in addition to the p-type board region Psub where the impurity such as boron is added to the wafer board made of silicon or the like of the mounting region Sw in the first embodiment, the mounting region Sw in the second embodiment includes the N-well region Nwell where an impurity such as phosphorus is added to the p-type board region Psub. The ground signal GND at the ground potential is supplied to the P-type board region Psub, and the voltage signal VHV is supplied to the N-well region Nwell. Here, the N-well region Nwell provided in the mounting region Sw in the second embodiment and the N-well region Nwell provided in the mounting region Sel may be an integrated region or separate regions separated from each other.

As in the first embodiment, the N-type diffusion layers 361, 362, 363, and the electrodes 364 and 365 are formed in the P-type board region Psub in the mounting region Sw. In addition, P-type diffusion layers 381, 382, 383, and electrodes 384 and 385 are formed in the N-well region Nwell in the mounting region Sw.

The P-type diffusion layers 381, 382, and 383 are located on the +y1 side of the N-type diffusion layers 361, 362, and 363, and are aligned in an order of the P-type diffusion layer 381, the P-type diffusion layer 382, and the P-type diffusion layer 383 from the −x2 side toward the +x2 side along the x2 axis. The electrodes 384 and 385 are aligned in an order of the electrode 384 and the electrode 385 from the −x2 side to the +x2 side along the x2 axis. At this time, in the plan view of the mounting region Sw, an end of the electrode 384 on the −x2 side overlaps a part of the P-type diffusion layer 381 and an end thereof on the +x2 side overlaps a part of the P-type diffusion layer 382, and in the plan view of the mounting region Sw, an end of the electrode 385 on the −x2 side overlaps a part of the P-type diffusion layer 382 and an end thereof on the +x2 side overlaps a part of the P-type diffusion layer 383. That is, in the plan view of the mounting region Sw, the electrode 384 is located between the P-type diffusion layer 381 and the P-type diffusion layer 382 to bridge the P-type diffusion layer 381 and the P-type diffusion layer 382, and in the plan view of the mounting region Sw, the electrode 385 is located between the P-type diffusion layer 382 and the P-type diffusion layer 383 to bridge the P-type diffusion layer 382 and the P-type diffusion layer 383. Between the electrode 384 and the N-well region Nwell and between the electrode 385 and the N-well region Nwell, oxide films or the like (not shown) are formed as insulating layers.

In the switch circuit 242 mounted in the mounting region Sw as described above, the drive voltage signal ComB is received by the N-type diffusion layers 361 and 363, and the P-type diffusion layers 381 and 383 via an electrode (not shown). The switch control signal SS is received by the electrodes 364, 365, 384, and 385. The switch circuit 242 mounted in the mounting region Sw outputs a signal of the N-type diffusion layer 362 and the P-type diffusion layer 382 as the drive voltage signal bCom via an electrode (not shown).

Specifically, when the H level switch control signal SS is received by the switch circuit 242 mounted in the mounting region Sw, in the plan view of the mounting region Sw, a channel having the channel width Wcn4 is formed in the P-type board region Psub overlapping the electrode 364 between the N-type diffusion layer 361 and the N-type diffusion layer 362, in the plan view of the mounting region Sw, a channel having the channel width Wcn4 is formed in the P-type board region Psub overlapping the electrode 365 between the N-type diffusion layer 362 and the N-type diffusion layer 363, in a plan view of the mounting region Sw, a channel having a channel width Wcn6 is formed in the N-well region Nwell overlapping the electrode 384 between the P-type diffusion layer 381 and the P-type diffusion layer 382, and in the plan view of the mounting region Sw, a channel having the channel width Wcn6 is formed in the N-well region Nwell overlapping the electrode 385 between the P-type diffusion layer 382 and the P-type diffusion layer 383. Accordingly, the drive voltage signal ComB supplied to the N-type diffusion layers 361 and 363, and the P-type diffusion layers 381 and 382 is supplied to the N-type diffusion layer 362 and the P-type diffusion layer 382, and is output as the drive voltage signal bCom.

The drive voltage signal bCom output from the N-type diffusion layer 362 and the P-type diffusion layer 382 mounted in the mounting region Sw is propagated through the wiring Wbc and received by the residual vibration detection circuit 250 mounted in the mounting region Amp.

That is, the N-type diffusion layers 361, 362, the electrode 364, the N-type diffusion layers 362, 363, and the electrode 365 constitute the n-type transistor 242a, and the P-type diffusion layers 381, 382, the electrode 384, the P-type diffusion layers 382, 383, and the electrode 385 constitute the p-type transistor 242b. At this time, the ground signal GND at the ground potential supplied to the P-type board region Psub is supplied to the back gate terminal of the n-type transistor 242a, and the voltage signal VHV supplied to the N-well region Nwell is supplied to a back gate terminal of the p-type transistor 242b.

As described above, in the liquid discharge apparatus 1 in the second embodiment, the drive voltage signal bCom and the residual vibration signal dVout are received by the residual vibration detection circuit 250 mounted in the mounting region Amp. The residual vibration detection circuit 250 mounted in the mounting region Amp amplifies the signal corresponding to the difference between the drive voltage signal ComB as the drive voltage signal bCom and the residual vibration signal Vout as the residual vibration signal dVout thus received, and thus generates and outputs the residual vibration detection signal NVT. That is, the residual vibration detection circuit 250 in the second embodiment outputs the residual vibration detection signal NVT obtained by differentially amplifying the residual vibration signal Vout received via the p-type transistor 238c and the drive voltage signal ComB received via the p-type transistor 242b.

In such a liquid discharge apparatus 1 in the second embodiment, the residual vibration detection circuit 250 still differentially amplifies the residual vibration signal Vout received via the p-type transistor 238c and the drive voltage signal ComB received via the p-type transistor 242b, and therefore, even when a ripple voltage of the voltage signal VHV received by the back gate terminal is superimposed on the residual vibration signal Vout received via the p-type transistor 238c, the ripple voltage is canceled out. As a result, the detection accuracy of the residual vibration generated after the piezoelectric element 60 is driven can be improved.

At this time, it is preferable that the wiring Wvo, which electrically couples the p-type transistor 238c of the selection circuit 230 mounted in the mounting region Sel and the residual vibration detection circuit 250 to propagate the residual vibration signal Vout as the residual vibration signal dVout, the wiring Wbc, which electrically couples the p-type transistor 238c of the switch circuit 242 mounted in the mounting region Sw and the residual vibration detection circuit 250 to propagate the drive voltage signal ComB as the drive voltage signal bCom, and the wiring Wvh, which propagates the voltage signal VHV to the mounting region Sel where the selection circuit 230 is mounted and the mounting region Sw where the switch circuit 242 is mounted and which propagates the voltage signal VHV supplied to the back gate terminal of the p-type transistor 238c of the selection circuit 230 and the back gate terminal of the p-type transistor 242b of the switch circuit 242, are provided such that, in the integrated circuit 300, at least a part of the wiring Wvo is disposed along the wiring Wvh, at least a part of the wiring Wbc is disposed along the wiring Wvh, and the wiring Wvh is located between the wiring Wvo and the wiring Wbc.

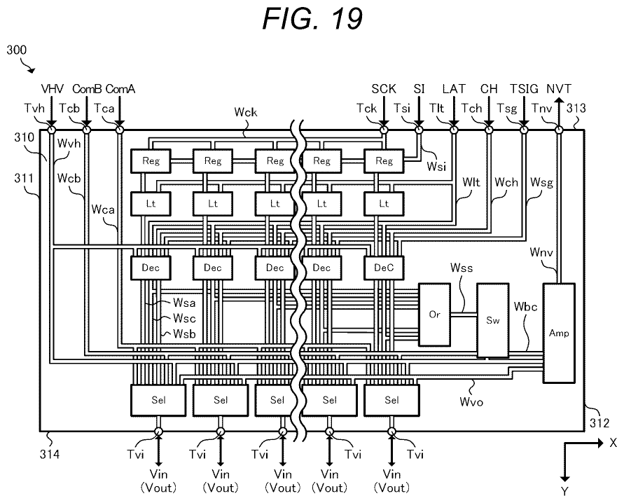

FIG. 19 shows an example of a structure of the integrated circuit 300 in the second embodiment, that is, the integrated circuit 300 where the drive signal selection circuit 200 of the liquid discharge apparatus 1 in the second embodiment is mounted. As shown in FIG. 19, in the integrated circuit 300 in the second embodiment, the wiring Wvh through which the voltage signal VHV is propagated extends along the Y axis that is a longitudinal direction of the integrated circuit 300 between the mounting region Dec and the mounting region Sel, and is electrically coupled to the m mounting regions Sel, the mounting region Sw, and the mounting region Amp. The wiring Wvo through which the residual vibration signal Vout as the residual vibration signal dVout is propagated is located between the mounting region Dec and the mounting region Sel on the +Y side of the wiring Wvh, and extends along the Y axis that is the longitudinal direction of the integrated circuit 300. The wiring Wbc through which the drive voltage signal ComB as the drive voltage signal bCom is propagated is located on the −Y side of the wiring Wvh and extends along the Y axis that is the longitudinal direction of the integrated circuit 300.

As shown in FIG. 19, between the mounting region Sw and the mounting region Amp, at least a part of the wiring Wvo is disposed along the wiring Wvh, at least a part of the wiring Wbc is disposed along the wiring Wvh, and the wiring Wvh is located between the wiring Wvo and the wiring Wbc. Accordingly, a difference between a degree of contribution of the ripple voltage of the voltage signal VHV to the residual vibration signal Vout as the residual vibration signal dVout propagated through the wiring Wvo and a degree of contribution of the ripple voltage of the voltage signal VHV to the drive voltage signal ComB as the drive voltage signal bCom propagated through the wiring Wbc can be reduced. Accordingly, it is possible to more accurately cancel out the ripple voltage of the voltage signal VHV superimposed on the residual vibration signal Vout in the residual vibration detection circuit 250 that differentially amplifies the residual vibration signal Vout received via the p-type transistor 238c and the drive voltage signal ComB received via the p-type transistor 242b. As a result, the detection accuracy of the residual vibration generated after the piezoelectric element 60 is driven can be further improved.

In the liquid discharge apparatus 1 in the second embodiment, the m mounting regions Sel are electrically coupled to the wiring Wvo. That is, m p-type transistors 238c whose back gate terminals are supplied with the voltage signal VHV are electrically coupled to the wiring Wvo. Accordingly, the ripple voltage of the voltage signal VHV may contribute to the residual vibration signal dVout propagated through the wiring Wvo via the back gate terminal provided at each of the m p-type transistors 238c.

From the viewpoint of reducing an influence of the ripple voltage of the voltage signal VHV contributing to the residual vibration signal dVout propagated through the wiring Wvo via the m p-type transistors 238c electrically coupled to such a wiring Wvo, it is preferable that a total width of channels of one or a plurality of transistors whose back gate terminals are supplied with the voltage signal VHV in one or a plurality of transistors electrically coupled to the wiring Wvo is substantially equal to a total width of channels of one or a plurality of transistors whose back gate terminals are supplied with the voltage signal VHV in one or a plurality of transistors electrically coupled to the wiring Wbc.

Specifically, in the integrated circuit 300 in the liquid discharge apparatus 1 in the second embodiment, the wiring Wvo is electrically coupled to the m mounting regions Sel. That is, m P-channel type transistors that are m transistors each formed of the P-type diffusion layers 371, 372, and the electrode 374, and m P-channel type transistors that are m transistors each formed of the P-type diffusion layers 372, 373, and the electrode 375 are electrically coupled to the wiring Wvo. Therefore, the total width of the channels of the one or the plurality of transistors whose back gate terminals are supplied with the voltage signal VHV in the one or the plurality of transistors electrically coupled to the wiring Wvo is “2×m×Wcn5”, that is, a sum of “m×Wcn5”, which is a total width of channels of the m P-channel type transistors each formed of the P-type diffusion layers 371, 372, and the electrode 374, and “m×Wcn5”, which is a total width of channels of the m P-channel type transistors each formed of the P-type diffusion layers 372, 373, and the electrode 375.

Meanwhile, in the integrated circuit 300 in the liquid discharge apparatus 1 in the second embodiment, the wiring Wbc is electrically coupled to the mounting region Sw. That is, transistors, namely, a P-channel type transistor formed of the P-type diffusion layers 381, 382, and the electrode 384, and a P-channel type transistor formed of the P-type diffusion layers 382, 383, and the electrode 385 are electrically coupled to the wiring Wvo. Therefore, the total width of the channels of the one or the plurality of transistors whose back gate terminals are supplied with the voltage signal VHV in the one or the plurality of transistors electrically coupled to the wiring Wbc is “2×Wcn6”, that is, a sum of “Wcn6”, which is a total width of channels of the P-channel type transistor formed of the P-type diffusion layers 381, 382, and the electrode 384, and “Wcn6”, which is a total width of channels of the P-channel type transistor formed of the P-type diffusion layers 382, 383, and the electrode 385.

By making “2×m×Wcn5”, which is the total width of the channels of the one or the plurality of transistors whose back gate terminals are supplied with the voltage signal VHV in the one or the plurality of transistors electrically coupled to the wiring Wvo, and “2×Wcn6”, which is the total width of the channels of the one or the plurality of transistors whose back gate terminals are supplied with the voltage signal VHV in the one or the plurality of transistors electrically coupled to the wiring Wbc, to be substantially equal to each other, it is possible to reduce the difference between the degree of contribution of the ripple voltage of the voltage signal VHV that contributes to the residual vibration signal dVout propagated through the wiring Wvo via the back gate terminals of the m p-type transistors 238c coupled to the wiring Wvo, and the degree of contribution of the ripple voltage of the voltage signal VHV that contributes to the drive voltage signal ComB as the drive voltage signal bCom propagated through the wiring Wbc. Accordingly, it is possible to more accurately cancel out the ripple voltage of the voltage signal VHV superimposed on the residual vibration signal Vout in the residual vibration detection circuit 250. As a result, the detection accuracy of the residual vibration generated after the piezoelectric element 60 is driven can be further improved.

That is, since a total channel width of a transistor group that includes the p-type transistor 238c and is formed of one or a plurality of transistors whose one ends are electrically coupled to the wiring Wvo and whose back gate terminals are supplied with the voltage signal VHV is substantially equal to a total channel width of a transistor group that includes the p-type transistor 242b and is formed of one or a plurality of transistors whose one ends are electrically coupled to the wiring Wbc and whose back gate terminals are supplied with the voltage signal VHV, it is possible to more accurately cancel out the ripple voltage of the voltage signal VHV superimposed on the residual vibration signal Vout in the residual vibration detection circuit 250. As a result, the detection accuracy of the residual vibration generated after the piezoelectric element 60 is driven can be further improved.

### 3. Modifications

In the liquid discharge apparatus 1 in the embodiment described above, the configuration in which the discharge portion 600 that discharges ink includes one pressure chamber 631 is shown as an example, but the configuration of the discharge portion 600 that discharges ink is not limited thereto, and for example, similar functions and effects can still be obtained with a configuration including two or more pressure chambers 631 for one nozzle 651 and the piezoelectric element 60 corresponding to each pressure chamber 631.

In the liquid discharge apparatus 1 in the embodiment, the piezoelectric element 60 is driven to change the volume of the pressure chamber 631 and the piezoelectric element 60 outputs the signal corresponding to the residual vibration caused by the change in the volume of the pressure chamber 631, and alternatively, the piezoelectric element 60 that changes the volume of the pressure chamber 631 and the piezoelectric element 60 that outputs the signal corresponding to the residual vibration caused by the change in the volume of the pressure chamber 631 may be different piezoelectric elements. With such a configuration, the same functions and effects are still obtained.

Although the embodiments and the modifications are described above, the disclosure is not limited to the embodiments and can be implemented in various aspects without departing from the gist thereof. For example, the above-described embodiments can be combined as appropriate.

The disclosure includes substantially the same configuration (for example, a configuration having the same function, the same method, and the same result, or a configuration having the same object and the same effect) as the configuration described in the embodiments. The disclosure includes configurations obtained by replacing non-essential portions of the configurations described in the embodiments. The disclosure includes configurations that can obtain the same functions and effects and configurations that can achieve the same object as the configurations described in the embodiments. The disclosure includes configurations obtained by adding a known technique to the configurations described in the embodiments.

The following contents are derived from the above-described embodiments.

An aspect of a print head includes:
a pressure chamber whose volume changes according to a drive signal;
a nozzle communicating with the pressure chamber and configured to allow a liquid to be discharged;
a piezoelectric element configured to output a residual vibration signal corresponding to a residual vibration caused by a change in the volume of the pressure chamber;
a residual vibration detection circuit configured to receive the residual vibration signal and output a residual vibration detection signal corresponding to the residual vibration signal; and
a first switch circuit configured to switch whether to supply the residual vibration signal to the residual vibration detection circuit, in which
the first switch circuit is an N-channel type transistor.

According to this print head, the first switch circuit that switches whether to supply the residual vibration signal to the residual vibration detection circuit is implemented by the N-channel type transistor, and thus a back gate terminal of the N-channel type transistor can be set to the ground potential. Accordingly, a risk that a ripple voltage of a signal such as a high-voltage signal supplied to the back gate terminal is superimposed on the residual vibration signal passing through the first switch circuit is reduced. As a result, accuracy of the residual vibration detection signal corresponding to the residual vibration signal output from the residual vibration detection circuit, that is, detection accuracy of the residual vibration caused by the change in the volume of the pressure chamber is improved.

In one aspect of the print head,
the piezoelectric element may displace according to the drive signal, and
the volume of the pressure chamber may change according to the displacement of the piezoelectric element.

According to this print head, it is not necessary to provide a dedicated piezoelectric element for generating the residual vibration in the pressure chamber, and a size of the print head can be reduced.

In one aspect of the print head,
a voltage value of the residual vibration signal during a period when the first switch circuit supplies the residual vibration signal to the residual vibration detection circuit may be smaller than a value obtained by subtracting, from a voltage value of a signal received by a control terminal of the first switch circuit, a voltage value of a threshold voltage for switching whether the first switch circuit supplies the residual vibration signal to the residual vibration detection circuit.

According to this print head, on-resistance of the N-channel type transistor that is the first switch circuit can be reduced. Accordingly, accuracy of the residual vibration detection signal corresponding to the residual vibration signal passing through the first switch circuit, that is, the detection accuracy of the residual vibration caused by the change in the volume of the pressure chamber is improved.

One aspect of the print head further includes:
a second switch circuit configured to switch whether to supply the drive signal to the residual vibration detection circuit, in which
the second switch circuit may be an N-channel type transistor.

According to this print head, a risk that a ripple voltage of a signal such as a high-voltage signal supplied to the back gate terminal is superimposed via the second switch circuit is reduced. As a result, the accuracy of the residual vibration detection signal corresponding to the residual vibration signal output from the residual vibration detection circuit, that is, the detection accuracy of the residual vibration caused by the change in the volume of the pressure chamber is improved.

In one aspect of the print head, the residual vibration detection circuit may output the residual vibration detection signal corresponding to a difference between the residual vibration signal received via the first switch circuit and the drive signal received via the second switch circuit.

According to this print head, the residual vibration detection circuit outputs the residual vibration detection signal corresponding to the difference between the residual vibration signal received via the first switch circuit that is the N-channel type transistor and the drive signal received via the second switch circuit that is the N-channel type transistor, and therefore, even when noise is superimposed on the residual vibration signal received via the first switch circuit that is the N-channel type transistor via the back gate terminal of the N-channel type transistor, the same noise is superimposed on the drive signal received via the second switch circuit that is the N-channel type transistor, and the noise superimposed via the back gate terminal of the N-channel type transistor is canceled out by extracting the difference. Therefore, the accuracy of the residual vibration detection signal corresponding to the residual vibration signal output from the residual vibration detection circuit, that is, the detection accuracy of the residual vibration caused by the change in the volume of the pressure chamber is improved.

An aspect of a liquid discharge apparatus includes:
a drive circuit configured to output a drive signal;
a pressure chamber whose volume changes according to the drive signal;
a nozzle communicating with the pressure chamber and configured to allow a liquid to be discharged;
a piezoelectric element configured to output a residual vibration signal corresponding to a residual vibration caused by a change in the volume of the pressure chamber;
a residual vibration detection circuit configured to receive the residual vibration signal and output a residual vibration detection signal corresponding to the residual vibration signal;
a first switch circuit configured to switch whether to supply the residual vibration signal to the residual vibration detection circuit; and
a processor configured to determine a discharge state of the liquid from the nozzle based on the residual vibration detection signal, in which
the first switch circuit is an N-channel type transistor.

According to this liquid discharge apparatus, the first switch circuit provided at the print head to switch whether to supply the residual vibration signal to the residual vibration detection circuit is implemented by the N-channel type transistor, and thus a back gate terminal of the N-channel type transistor can be set to the ground potential. Accordingly, a risk that a ripple voltage of a signal such as a high-voltage signal supplied to the back gate terminal is superimposed on the residual vibration signal passing through the first switch circuit is reduced. As a result, accuracy of the residual vibration detection signal corresponding to the residual vibration signal output from the residual vibration detection circuit, that is, detection accuracy of the residual vibration caused by the change in the volume of the pressure chamber is improved.

In one aspect of the liquid discharge apparatus,
the piezoelectric element may displace according to the drive signal, and
the volume of the pressure chamber may change according to the displacement of the piezoelectric element.

According to this liquid discharge apparatus, it is not necessary to provide a dedicated piezoelectric element for generating the residual vibration in the pressure chamber, and a size of the liquid discharge apparatus can be reduced.

In one aspect of the liquid discharge apparatus,
a voltage value of the residual vibration signal during a period when the first switch circuit supplies the residual vibration signal the residual vibration detection circuit may be smaller than a value obtained by subtracting, from a voltage value of a signal received by a control terminal of the first switch circuit, a voltage value of a threshold voltage for switching whether the first switch circuit supplies the residual vibration signal to the residual vibration detection circuit.

According to this liquid discharge apparatus, on-resistance of the N-channel type transistor that is the first switch circuit can be reduced. Accordingly, accuracy of the residual vibration detection signal corresponding to the residual vibration signal passing through the first switch circuit, that is, the detection accuracy of the residual vibration caused by the change in the volume of the pressure chamber is improved.

One aspect of the liquid discharge apparatus further includes:
a second switch circuit configured to switch whether to supply the drive signal to the residual vibration detection circuit, in which
the second switch circuit may be an N-channel type transistor.

According to this liquid discharge apparatus, a risk that a ripple voltage of a signal such as a high-voltage signal supplied to the back gate terminal is superimposed via the second switch circuit is reduced. As a result, the accuracy of the residual vibration detection signal corresponding to the residual vibration signal output from the residual vibration detection circuit, that is, the detection accuracy of the residual vibration caused by the change in the volume of the pressure chamber is improved.

In one aspect of the liquid discharge apparatus,
the residual vibration detection circuit may output the residual vibration detection signal corresponding to a difference between the residual vibration signal received via the first switch circuit and the drive signal received via the second switch circuit.

According to this liquid discharge apparatus, the residual vibration detection circuit outputs the residual vibration detection signal corresponding to the difference between the residual vibration signal received via the first switch circuit that is the N-channel type transistor and the drive signal received via the second switch circuit that is the N-channel type transistor, and therefore, even when noise is superimposed on the residual vibration signal received via the first switch circuit that is the N-channel type transistor via the back gate terminal of the N-channel type transistor, the same noise is superimposed on the drive signal received via the second switch circuit that is the N-channel type transistor, and the noise superimposed via the back gate terminal of the N-channel type transistor is canceled out by extracting the difference. Therefore, the accuracy y of the residual vibration detection signal corresponding to the residual vibration signal output from the residual vibration detection circuit, that is, the detection accuracy of the residual vibration caused by the change in the volume of the pressure chamber is improved.

What is claimed is:

1. A print head comprising:
a pressure chamber whose volume changes according to a drive signal;
a nozzle communicating with the pressure chamber and configured to allow a liquid to be discharged;
a piezoelectric element configured to output a residual vibration signal corresponding to a residual vibration caused by a change in the volume of the pressure chamber;
a residual vibration detection circuit configured to receive the residual vibration signal and output a residual vibration detection signal corresponding to the residual vibration signal; and
a first switch circuit configured to switch whether to supply the residual vibration signal to the residual vibration detection circuit, wherein
the first switch circuit N-channel type transistor.

2. The print head according to claim 1, wherein
the piezoelectric element displaces according to the drive signal, and
the volume of the pressure chamber changes according to the displacement of the piezoelectric element.

3. The print head according to claim 1, wherein
a voltage value of the residual vibration signal during a period when the first switch circuit supplies the residual vibration signal to the residual vibration detection circuit is smaller than a value obtained by subtracting, from a voltage value of a signal received by a control terminal of the first switch circuit, a voltage value of a threshold voltage for switching whether the first switch circuit supplies the residual vibration signal to the residual vibration detection circuit.

4. The print head according to claim 1, further comprising:
a second switch circuit configured to switch whether to supply the drive signal to the residual vibration detection circuit, wherein
the second switch circuit is an N-channel type transistor.

5. The print head according to claim 4, wherein
the residual vibration detection circuit outputs the residual vibration detection signal corresponding to a difference between the residual vibration signal received via the first switch circuit and the drive signal received via the second switch circuit.

6. A liquid discharge apparatus comprising:
a drive circuit configured to output a drive signal;
a pressure chamber whose volume changes according to the drive signal;
a nozzle communicating with the pressure chamber and configured to allow a liquid to be discharged;
a piezoelectric element configured to output a residual vibration signal corresponding to a residual vibration caused by a change in the volume of the pressure chamber;
a residual vibration detection circuit configured to receive the residual vibration signal and output a residual vibration detection signal corresponding to the residual vibration signal;
a first switch circuit configured to switch whether to supply the residual vibration signal to the residual vibration detection circuit; and
a processor configured to determine a discharge state of the liquid from the nozzle based on the residual vibration detection signal, wherein
the first circuit is an N-channel type switch transistor.

7. The liquid discharge apparatus according to claim 6, wherein
the piezoelectric element displaces according to the drive signal, and
the volume of the pressure chamber changes according to the displacement of the piezoelectric element.

8. The liquid discharge apparatus according to claim 6, wherein
a voltage value of the residual vibration signal during a period when the first switch circuit supplies the residual vibration signal to the residual vibration detection circuit is smaller than t a value obtained by subtracting, from a voltage value of a signal received by a control terminal of the first switch circuit, a voltage value of a threshold voltage for switching whether the first switch circuit supplies the residual vibration signal to the residual vibration detection circuit.

9. The liquid discharge apparatus according to claim 6, further comprising:
a second switch circuit configured to switch whether to supply the drive signal to the residual vibration detection circuit, wherein
the second switch circuit is an N-channel type transistor.

10. The liquid discharge apparatus according to claim 9, wherein
the residual vibration detection circuit outputs the residual vibration detection signal corresponding to a difference between the residual vibration signal received via the first switch circuit and the drive signal received via the second switch circuit.
